(19) United States
(12) Patent Application Publication
(10) Pub. No.: US 2007/0158440 A1
(43) Pub. Date: Jul. 12, 2007

(54) SEMICONDUCTOR DEVICE

(75) Inventors: Hirotaka Nishizawa, Tokyo (JP); Norihisa Yamamoto, Tokyo (JP); Jun Miyake, Tokyo (JP); Junichiro Osako, Tokyo (JP); Minoru Shinohara, Tokyo (JP); Tamaki Wada, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/566,985

(22) Filed: Dec. 5, 2006

(30) Foreign Application Priority Data
Jan. 6, 2006 (JP) 2006-1061

(51) Int. Cl. G06K 19/06

(52) U.S. Cl. 235/492

(57) ABSTRACT

A semiconductor device improved in IC card function is disclosed. An external connecting terminal for extended interface not conforming to ISO/IEC7816-3 is disposed on a first main surface of a card chip and in an area sandwiched in between two rows of external connecting terminals for interface conforming to ISO/IEC7816-3 which is for IC card function. With this layout, the memory card function and other electronic circuit functions can be incorporated into the card chip and hence it is possible to improve the function of the card chip.

### CROSS-REFERENCE TO RELATED APPLICATION

The present application claims priority from Japanese patent application No. 2006-1061 filed on Jan. 6, 2006, the content of which is hereby incorporated by reference into this application.

### BACKGROUND OF THE INVENTION

The present invention relates to a semiconductor device technique and more particularly to a technique applicable effectively to a card type information medium.

Card type information media such as IC card and memory card are small-sized and reduced in thickness and weight, so are superior in portability and convenience and are being spread in various fields.

The IC card is a card type information medium having an IC chip embedded in a thin plastic sheet of the cash card size to permit recording of information therein. By reason of being superior in authenticatability and tamper resistance, IC cards, e.g., credit cards, cash cards, cards for ETC (Electronic Toll Collection system), season tickets, portable telephone cards and authentication cards, are being spread more and more in fields in which high security is required such as the fields of finance, traffic, communication, distribution and authentication. As an example of such IC cards, in FIG. 9 of Japanese Unexamined Patent Publication No. 2001-357376 (Patent Literature 1) there is illustrated a construction wherein a bridge is provided in an aperture of a frame card to fix a card of SIM (Subscriber Identify Module) type.

On the other hand, the foregoing memory card is a card type information medium which adopts a flash memory as a storage medium. The memory card is smaller in size than the IC card and can easily write and read a large capacity of information at high speed. Therefore, the memory card is in wide spread as a recording medium in portable information devices for which portability is required such as, for example, digital cameras, notebook-size personal computers, portable music players and portable telephones. As typical memory card standards there are SD (Secure Digital) Memory Card (there is a standard defined by SD Card Association), mini SD, MMD (Multi Media Card, a registered trademark of Infineon Technologies AG), and RS-MMC (Reduced Size MMC). A description on such memory cards is found, for example, in WO 02/099742 Pamphlet (Patent Literature 2), in which for the purpose of improving security there is disclosed a construction of a memory card including a flash memory chip, an IC card chip able to execute a security processing and a controller chip for controlling circuit operations of those chips.

[Patent Literature 1]

Japanese Unexamined Patent Publication No. 2001-357376

[Patent Literature 2]

WO 02/099742 Pamphlet

### SUMMARY OF THE INVENTION

The SIM card as an example of the above IC card is a card type information medium in which is recorded information (e.g., telephone number, user ID and telephone call fee) of a portable telephone subscriber, and is used by inserting it into a portable telephone terminal of GSM type. In a service mode wherein subscriber information is registered in a portable telephone terminal itself, it is necessary to rewrite information from one terminal to another at every change of the type of the portable telephone terminal. On the other hand, in a service mode using the SIM card, plural portable telephone terminals can be used properly with a single SIM card; besides, if the user possesses an SIM card of another common carrier, plural common traders can be utilized properly by a single portable telephone terminal.

However, in connection with the SIM card, a further reduction of size is being conducted from the standpoint of reducing the size of portable telephone terminals and incorporating the SIM card into a still smaller portable electronic device, and at the same time a further improvement of function is being required. Consequently, in connection with the IC card which is being made smaller and smaller in size, it is an important problem how an interface of the memory card function and of other electronic circuit functions is to be incorporated in the IC card to improve the function.

Accordingly, it is an object of the present invention to provide a technique capable of improving the function of IC card.

The above and other objects and novel features of the present invention will become apparent from the following description and the accompanying drawings.

The following is a brief description of a typical mode of the present invention as disclosed herein.

In the present invention, rows of IS07816 terminals are arranged on a first main surface of a card body which incorporates a card circuit comprising an IC card circuit and a memory card circuit, and a non-IS07816 terminal is disposed in an area sandwiched in between the rows of ISO7816 terminals.

The following is a brief description of an effect obtained by the typical mode of the present invention as disclosed herein.

Since the non-ISO7816 terminal is disposed in the area sandwiched in between the rows of ISO7816 terminals disposed on the first main surface of the card body which incorporates a card circuit comprising an IC card circuit and a memory card circuit, the memory card function and other electronic circuit functions can be incorporated in the IC card, whereby the function of the IC card can be improved.

### BRIEF DESCRIPTION OF THE DRAWINGS

FIG. 1 is an entire plan view of a first main surface of an IC card having a semiconductor device according to an embodiment of the present invention;

FIG. 2 is an entire plan view of a second main surface as a back side of the first main surface of the IC card shown in FIG. 1;

FIG. 3 is a side view of the IC card shown in FIGS. 1 and 2;

FIG. 4 is a perspective view of a first main surface side of a card body of the IC card shown in FIG. 1;

FIG. 5 is a perspective view of a second main surface side of the card body of the IC card shown in FIG. 1;

FIG. 6 is a sectional view taken on line X1-X1 in FIG. 5;

FIG. 7 is an exploded perspective view of the IC card body of the IC card shown in FIG. 1;

FIG. 8 is a plan view of a first main surface of a principal portion of the card body shown in FIG. 4;

FIG. 9 is a plan view of a second main surface of the principal portion of the card body shown in FIG. 8;

FIG. 10 is a plan view of the second main surface of the principal portion of the card body shown in FIG. 8;

FIG. 11 is a sectional view taken on line X2-X2 in FIGS. 9 and 10;

FIG. 12 is a sectional view taken on line X2-X2 in FIGS. 9 and 10, showing a modification of FIG. 11;

FIG. 13 is an enlarged plan view of external connecting terminals on the first main surface of the principal portion of the card body shown in FIG. 8;

FIG. 14 is a sectional view taken on line X3-X3 in FIG. 13;

FIG. 15 is a sectional view taken on line X3-X3 in FIG. 13, showing a modification of FIG. 14;

FIG. 16 is a sectional view taken on line X3-X3 in FIG. 13, showing another modification of FIG. 14;

FIG. 17 is a plan view of a second main surface of a wiring board, showing a modification of construction of semiconductor chips in the principal portion of the card body shown in FIG. 8;

FIG. 18 is a plan view of the second main surface of the wiring board, showing another modification of construction of semiconductor chips in the principal portion of the card body shown in FIG. 8;

FIG. 19 is a plan view of the second main surface of the wiring board, showing a further modification of construction of semiconductor chips in the principal portion of the card body shown in FIG. 8;

FIG. 20 is an entire plan view of the first main surface of the card body, showing an example of function of external connecting terminals in the card body shown in FIG. 4;

FIG. 21 is a circuit diagram for explaining a circuit operation performed in accordance with signals inputted to external connecting terminals for extended interface in the card body shown in FIG. 4;

FIG. 22 is a circuit diagram for explaining circuit operations performed in accordance with signals inputted to the external connecting terminals for extended interface in the card body shown in FIG. 4;

FIG. 23 is a diagram illustrating an example of an IC card microcomputer circuit formed in the card body shown in FIG. 4;

FIG. 24 is a diagram illustrating an example of an interface controller circuit formed in the card body shown in FIG. 4;

FIG. 25 is a diagram illustrating another example of an IC card microcomputer circuit formed in the card body shown in FIG. 4;

FIG. 26 is a diagram illustrating another example of an interface controller circuit formed in the card body shown in FIG. 4;

FIG. 27 is a perspective view on a first main surface side of a card body of an IC card having a semiconductor device according to another embodiment of the present invention;

FIG. 28 is an exploded perspective view of the card body shown in FIG. 27;

FIG. 29 is a perspective view on a first main surface side of a card body of an IC card having a semiconductor device according to a further embodiment of the present invention;

FIG. 30 is an exploded perspective view of the card body shown in FIG. 29;

FIG. 31 is a perspective view on a first main surface side of a card body of an IC card having a semiconductor device according to a still further embodiment of the present invention;

FIG. 32 is an exploded perspective view of the card body shown in FIG. 31;

FIG. 33 is a perspective view of a first main surface side of a card body as a semiconductor device according to a still further embodiment of the present invention;

FIG. 34 is a perspective view of a second main surface side of the card body shown in FIG. 33;

FIG. 35 is a sectional view taken on line X4-X4 in FIG. 34;

FIG. 36 is a plan view of a first main surface of a card body of an IC card having a semiconductor device according to a still further embodiment of the present invention;

FIG. 37 is an entire plan view of a first main surface of an IC card having a semiconductor device according to a still further embodiment of the present invention;

FIG. 38 is an entire plan view of a second main surface of the IC card shown in FIG. 37;

FIG. 39 is a side view of the IC card shown in FIGS. 37 and 38;

FIG. 40 is a perspective view of a first main surface side of a card body shown in FIGS. 37 and 38;

FIG. 41 is a perspective view of a second main surface side of the card body shown in FIG. 40;

FIG. 42 is an exploded perspective view of the card body shown in FIG. 40;

FIG. 43 is a perspective view of a first main surface side of a card body of an IC card having a semiconductor device according to a still further embodiment of the present invention;

FIG. 44 is a perspective view of a second main surface side of the card body shown in FIG. 43;

FIG. 45 is a sectional view taken on line X5-X5 in FIG. 44;

FIG. 46 is an exploded perspective view of the card body shown in FIG. 43;

FIG. 47 is a perspective view of a first main surface side of a card body according to a still further embodiment of the present invention;

FIG. 48 is a perspective view of a second main surface side of the card body shown in FIG. 47;

FIG. 49 is an entire plan view of a first main surface of an IC card having a semiconductor device according to a still further embodiment of the present invention;

FIG. 50 is an entire plan view of a second main surface of the IC card shown in FIG. 49;

FIG. 51 is a side view of the IC card shown in FIGS. 49 and 50;

FIG. 52 is a perspective view of a first main surface side of a card body shown in FIGS. 49 and 50;

FIG. 53 is a perspective view of a second main surface side of the cad body shown in FIGS. 49 and 50;

FIG. 54 is a sectional view taken on line X6-X6 in FIG. 53;

FIG. 55 is an exploded perspective view of the card body shown in FIGS. 49 and 50;

FIG. 56 is a plan view of a first main surface of a main chip portion of the card body shown in FIG. 52;

FIG. 57 is a plan view of a second main surface of the main chip portion shown in FIG. 56;

FIG. 58 is a plan view of the second main surface of the main chip portion shown in FIG. 56;

FIG. 59 is a sectional view taken on line X7-X7 in FIGS. 57 and 58;

FIG. 60 is a sectional view taken on line X7-X7 in FIGS. 57 and 58, showing a modification of FIG. 59;

FIG. 61 is an entire plan view of a first main surface of the card body, showing an example of function of external connecting terminals in the card body shown in FIG. 52;

FIG. 62 is an entire plan view of the first main surface of the card body, showing another example of function of the external connecting terminals in the card body shown in FIG. 52;

FIG. 63 is a diagram illustrating an example of use of the card body shown in FIG. 62;

FIG. 64 is a diagram illustrating another example of use of the card body shown in FIG. 62;

FIG. 65 is a perspective view of a first main surface side of a card body of an IC card having a semiconductor device according to a still further embodiment of the present invention;

FIG. 66 is an exploded perspective view of the card body shown in FIG. 65;

FIG. 67 is a perspective view of a first main surface side of a card body of an IC card having a semiconductor device according to a still further embodiment of the present invention;

FIG. 68 is an exploded perspective view of the card body shown in FIG. 67;

FIG. 69 is a perspective view of a first main surface side of a card body of an IC card having a semiconductor device according to a still further embodiment of the present invention;

FIG. 70 is an exploded perspective view of the card body shown in FIG. 69;

FIG. 71 is a perspective view of a first main surface side of a card body according to a still further embodiment of the present invention;

FIG. 72 is a perspective view on a second main surface side of the card body shown in FIG. 71;

FIG. 73 is a sectional view taken on line X8-X8 in FIG. 72;

FIG. 74 is an entire plan view of a first main surface of an IC card having a semiconductor device according to a still further embodiment of the present invention;

FIG. 75 is an entire plan view of a second main surface of the IC card shown in FIG. 74;

FIG. 76 is a side view of the IC card shown in FIG. 75;

FIG. 77 is a perspective view of a first main surface side of a card body of the IC card shown in FIGS. 74 and 75;

FIG. 78 is a perspective view of a second main surface side of the card body shown in FIG. 77;

FIG. 79 is an exploded perspective view of the card body shown in FIG. 77;

FIG. 80 is a perspective view of a first main surface side of a card body of an IC card having a semiconductor device according to a still further embodiment of the present invention;

FIG. 81 is a perspective view of a second main surface side of the card body shown in FIG. 80;

FIG. 82 is a sectional view taken on line X9-X9 in FIG. 81;

FIG. 83 is a plan view of a first main surface of a main chip portion of the card body shown in FIG. 80;

FIG. 84 is a plan view of a second main surface of the main chip portion shown in FIG. 83;

FIG. 85 is a plan view of the second main surface of the main chip portion shown in FIG. 83;

FIG. 86 is a sectional view taken on line X10-X10 in FIGS. 84 and 85;

FIG. 87 is a sectional view taken on line X10-X10 in FIGS. 84 and 85, showing a modification of FIG. 86;

FIG. 88 is an enlarged plan view of external connecting terminals on a wiring board of the main chip portion shown in FIG. 83;

FIG. 89 is a sectional view taken on line X11-X11 in FIG. 88;

FIG. 90 is a sectional view taken on line X11-X11 in FIG. 88, showing a modification of FIG. 89;

FIG. 91 is a sectional view taken on line X11-X11 in FIG. 88, showing another modification of FIG. 89;

FIG. 92 is an entire plan view of a first main surface of a wiring board, illustrating a layout area of external connecting terminals for extended interface in the main chip portion shown in FIG. 83;

FIG. 93 is an entire plan view of the first main surface of the wiring board, illustrating a layout area of wiring in the main chip portion shown in FIG. 83;

FIG. 94 is an entire plan view of the first main surface of the wiring board, showing concrete examples of dimensions related to the external connecting terminals in the main chip portion shown in FIG. 83;

FIG. 95 is a sectional view of a principal portion of the wiring board where a through hole extending through both upper and lower surfaces of an external connecting terminal is formed in a connection area of the external connecting terminal in the IC card according to the present invention;

FIG. 96 is an enlarged plan view of a principal portion of an external connecting terminal on the wiring board in the main chip portion shown in FIG. 83;

FIG. 97 is a plan view of a principal portion of the wiring board wherein solder resist partially covers the outer periphery of an upper surface of an external connecting terminal;

FIG. 98 is an enlarged sectional view taken on line X12-X12 in FIG. 97;

FIG. 99 is an enlarged plan view of a principal portion of an external connecting terminal on the wiring board in the main chip portion shown in FIG. 83;

FIG. 100 is an entire plan view of a first main surface of the card body, showing an example of function of external connecting terminals in the card body shown in FIG. 80;

FIG. 101 is an entire plan view of the first main surface of the card body, showing another example of function of the external connecting terminals in the card body shown in FIG. 80;

FIG. 102 is a perspective view of a first main surface side of a card body of an IC card having a semiconductor device according to a still further embodiment of the present invention;

FIG. 103 is a perspective view of a second main surface side of the card body shown in FIG. 102;

FIG. 104 is a sectional view taken on line X13-X13 in FIG. 103;

FIG. 105 is a perspective view of a first main surface side of a card body according to a still further embodiment of the present invention;

FIG. 106 is a perspective view of a second main surface side of the card body shown in FIG. 105;

FIG. 107 is a sectional view taken on line X14-X14 in FIG. 106;

FIG. 108 is a perspective view of a first main surface side of a card body of an IC card having a semiconductor device according to a still further embodiment of the present invention; and

FIG. 109 is a perspective view of a second main surface side of the card body shown in FIG. 108.

### DETAILED DESCRIPTION OF PREFERRED EMBODIMENTS

Where required for convenience' sake, the following embodiments will each be described in a divided manner into plural sections or embodiments, but unless otherwise mentioned, they are not unrelated to each other but are in a relation such that one is a modification or a detailed or supplementary explanation of part or the whole of the other. In the following embodiments, when reference is made to the number of elements (including the number, numerical value, quantity and range), no limitation is made to the number referred to, but numerals above and below the number referred to will do as well unless otherwise mentioned and except the case where it is basically evident that limitation is made to the number referred to. It goes without saying that in the following embodiments their constituent elements (including constituent steps) are not always essential unless otherwise mentioned and except the case where they are considered essential basically obviously. Likewise, it is to be understood that when reference is made to the shapes and positional relation of constituent elements in the following embodiments, those substantially closely similar to or resembling such shapes, etc. are also included unless otherwise mentioned and except the case where a negative answer is evident basically. This is also true of the following numerical value and range. Moreover, in all of the drawings for illustrating the following embodiments, portions having the same functions are identified by like reference numerals, and repeated explanations thereof will be omitted if possible. Embodiments of the present invention will be described hereinunder with reference to the drawings.

### First Embodiment

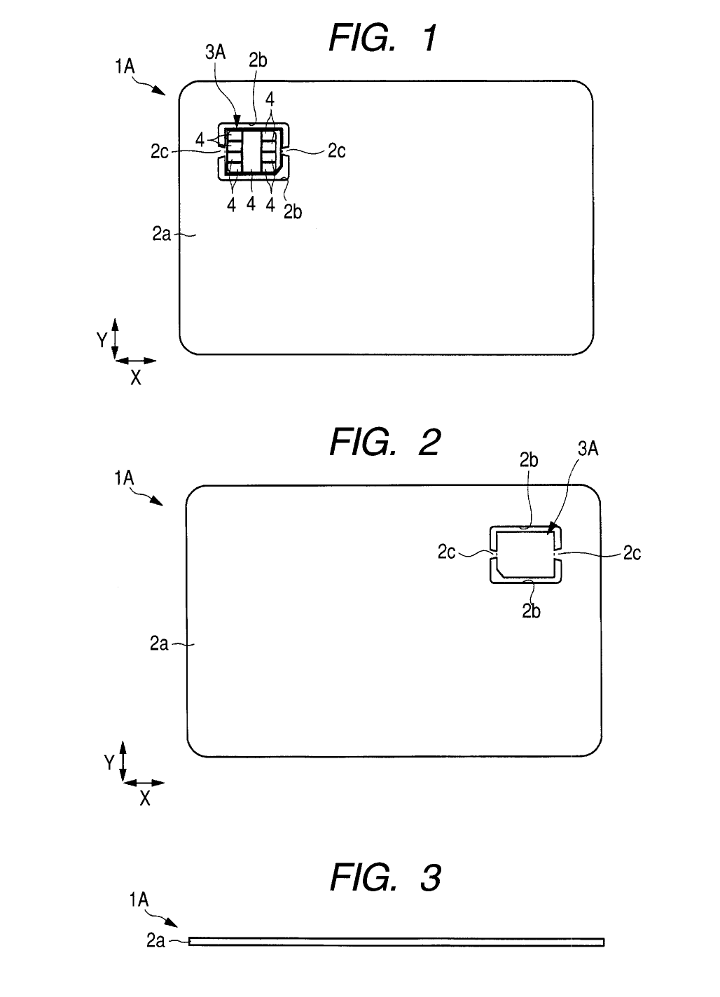

FIG. 1 is an entire plan view of a first main surface of an IC (Integrated Circuit) card 1A having a semiconductor device according to a first embodiment of the present invention, FIG. 2 is an entire plan view of a second main surface as a back side of the first main surface of the IC card 1A shown in FIG. 1, and FIG. 3 is a side view of the IC card 1A shown in FIGS. 1 and 2. The reference mark X represents a first direction (longitudinal direction of the IC card) and the mark Y represents a second direction (transverse direction of the IC card 1A) orthogonal to the first direction.

The IC card 1A is a subscriber identity module (card type information medium) called for example mini UICC (mini Universal Integrated Circuit Card), SIM (Subscriber Identify Module) card, or UIM (User Identity Module) card. An outline of the IC card 1A is formed for example in a generally rectangular shape and outline dimensions of the IC card 1A are, for example, about 85.6 mm×54 mm×0.76 mm.

A card frame (frame portion) 2a which defines an outline of the IC card 1A is formed using a plastic material, e.g., polyvinyl chloride (PVC), polycarbonate, polyolefin (e.g., polypropylene), polyethylene terephthalate (PET), polyethylene terephthalate glycol (PET-G), or ABS (acrylnitrile butadiene styrene resin).

An aperture 2b is formed in the card frame 2a of the IC card 1A in a position spaced away from the center of the card frame and close to a corner, the aperture 2b extending through both first and second main surfaces of the IC card 1A. An IC card chip (card body, hereinafter referred to as “card chip”) 3A is fitted in the aperture 2b snugly in a state in which it is joined to and supported by the card frame 2a through support portions 2c.

The card chip 3A is a subscriber identity module of high functionality having both function as an IC card and a higher function larger in capacity than the IC card, i.e., function as a memory card. That is, the card chip 3A is employable as a card for portable telephone with information such as telephone number or telephone directory stored therein. Moreover, the card chip 3A is employable in various fields for which high security is required such as the fields of finance, traffic, communication, distribution and authentication, like credit card, cash card, card for ETC (Electronic Toll Collection system), season ticket, or authentication card. Besides, the construction of the card chip 3A permits use thereof also as a recording medium in portable information devices for which portability is required such as, for example, digital cameras, notebook-size personal computers, portable music players and portable telephones.

Plural external connecting terminals 4 are disposed on a first main surface of the card chip 3A in an exposed state to the exterior. The external connecting terminals 4 are electrodes for electric connection between the card chip 3A and an external device. The card chip 3A can be taken out by cutting off the support portions 2c with use of a simple cutting tool such as a cutter knife or manually.

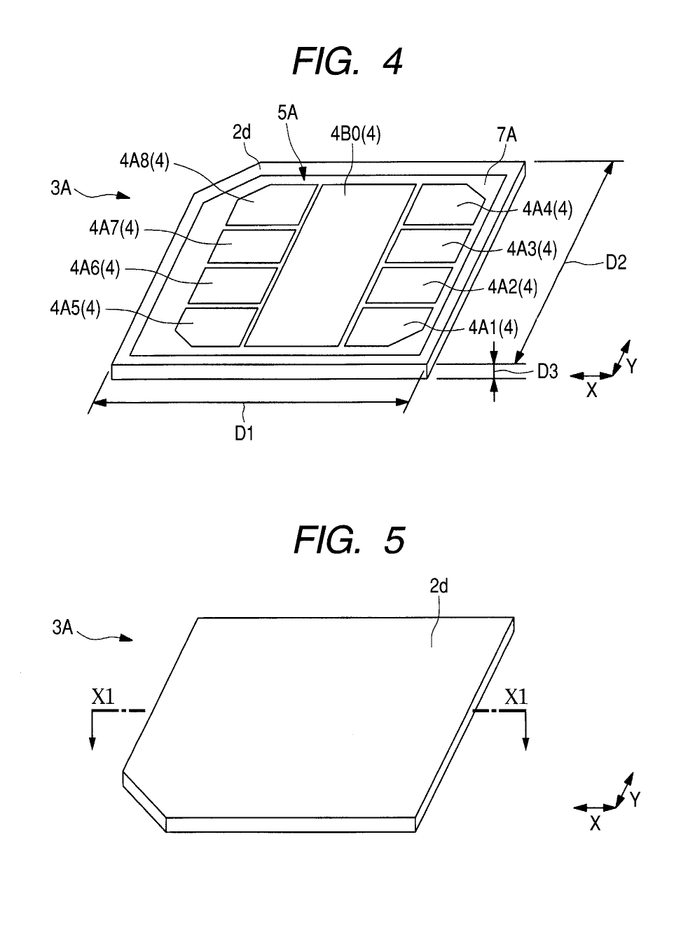

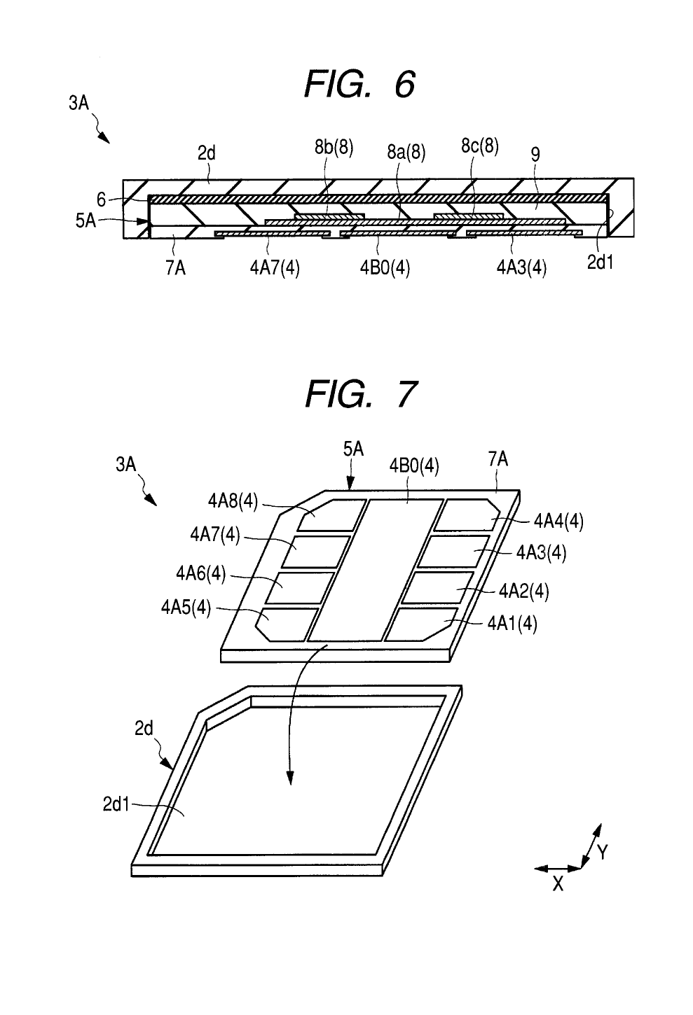

FIG. 4 is a perspective view of the first main surface side of the card chip 3A, FIG. 5 is a perspective view of a second main surface side of the card chip 3A, FIG. 6 is a sectional view taken on line X1-X1 in FIG. 5, and FIG. 7 is an exploded perspective view of the card chip 3A shown in FIGS. 4 and 5.

The outline of the card chip 3A is in conformity with the outline standard of mini-size SIM card and mini UICC card. Its plane is in a quadrangular shape for example. One corner on the front side of the card chip 3A is largely chamfered for index, presenting a polygonal shape. Outline dimensions (D1×D2×D3) of the card chip 3A are, for example, about 15 mm×12 mm×0.76 mm assuming that the planar shape thereof is a quadrangular shape exclusive of the chamfered portion. That is, planar dimensions are 15 mm×12 mm and the thickness is about 0.76 mm. Although in the drawings related to this embodiment the corner in question is depicted in the foregoing polygonal shape, the corner may be rounded. By such rounding, a user who uses the card chip 3A of this embodiment can be prevented from suffering an accident such as being wounded by a sharp corner. In the drawings related to this embodiment the corner is not rounded for the simplification of explanation.

Eight external connecting terminals (ISO7816 terminals) 4A1 to 4A8 (4) for interface conforming to ISO/IEC7816-3 which is for IC card function and one external connecting terminal (non-ISO7816 terminal, extend terminal) 4B0 (4) for extended interface not conforming to ISO/IEC7816-3 are disposed on the first main surface of the card chip 3A (on the first main surface side of the IC card 1A) in an exposed state to the exterior. The external connecting terminals 4A1 to 4A8 are arranged in two rows on the first main surface of the card chip 3A, of which the external connecting terminals 4A1 to 4A4 are arranged in one row along a rear side of the card chip 3A and the external connecting terminals 4A5 to 4A8 are arranged in one row along a front side of the card chip 3A. An external connecting terminal 4B0 is disposed in an area sandwiched in between the two rows of the external connecting terminals 4A1 to 4A4 and 4A5 to 4A8. The external connecting terminal 4B0 is formed in a rectangular shape larger than each of the external connecting terminals 4A1 to 4A8. The external connecting terminal 4B0 extends from end to end in the first direction X so as not to contact the external connecting terminals 4A1 to 4A4 and 4A5 to 4A8. Further, the external connecting terminal 4B0 extends from end to end in the second direction Y.

By thus disposing the external connecting terminal 4B0 (4) for extended interface in the area located between the rows of external connecting terminals 4A1 to 4A4 and 4A5 to 4A8 conforming to ISO/IEC7816-3, it is possible to incorporate the memory card function and another electronic circuit function into the card chip 3A and hence possible to improve the function of the card chip 3A.

The card chip 3A has a main chip portion 5A and a cap 2d (case body 2d). The main chip portion 5A is a main member provided on its first main surface (the first main surface side of IC card 1A and card chip 3A) with the foregoing plural external connecting terminals 4. A planar size of the main chip portion 5A is set a little smaller than that of the card chip 3A. A planar shape of the main chip portion 5A is analogous to that of the card chip 3A and one corner on a front side of the main chip portion 5A is largely chamfered. Such a chamfered portion is formed lest the card chip 3A should be inserted in a wrong direction when it is to be inserted into an external device. On the other hand, the cap 2d is formed as a case body which defines the outline of the card chip 3A. The cap 2d is formed using the same material as that of the card frame 2a. Thus, the cap 2d can be formed integrally with and using the same material as the card frame 2a and hence it is possible to simplify the manufacturing process. Moreover, since the cap 2d is formed of the foregoing plastic material, its elastic force can be enhanced to a greater extent than a sealing body 9 which will be described later. That is, since the cap 2d is formed using a material softer than the sealing body 9, even if a shock is imposed on the card chip 3A from the exterior, it is possible to ensure reliability. Thus, the cap 2d functions as a protective film for the main chip portion 5A.

A recess 2d1 is formed in a first main surface of the cap 2d (the first main surface side of the IC card 1A and card chip 3A), the recess 2d1 having a planar size somewhat larger than that of the main chip portion 5A and having a shape analogous to the planar shape of the main chip portion 5A. A planar position of the chamfered portion of the main chip portion 5A is made coincident with that of a chamfered portion of an inner wall corner of the recess 2d1, then in this state and in a state in which the external connecting terminals 4 on the main chip portion 5A face outwards, the main chip portion 5A is joined firmly to the cap 2d through an adhesive 6 fitted snugly into the recess 2d1. In this case, since the main chip portion 5A is fitted into the recess 2d1 in an aligned state between the chamfered portion of the main chip portion 5A and the chamfered portion of the recess 2d1 of the cap 2d, it is possible to prevent the main chip portion 5A from being inserted in a wrong direction.

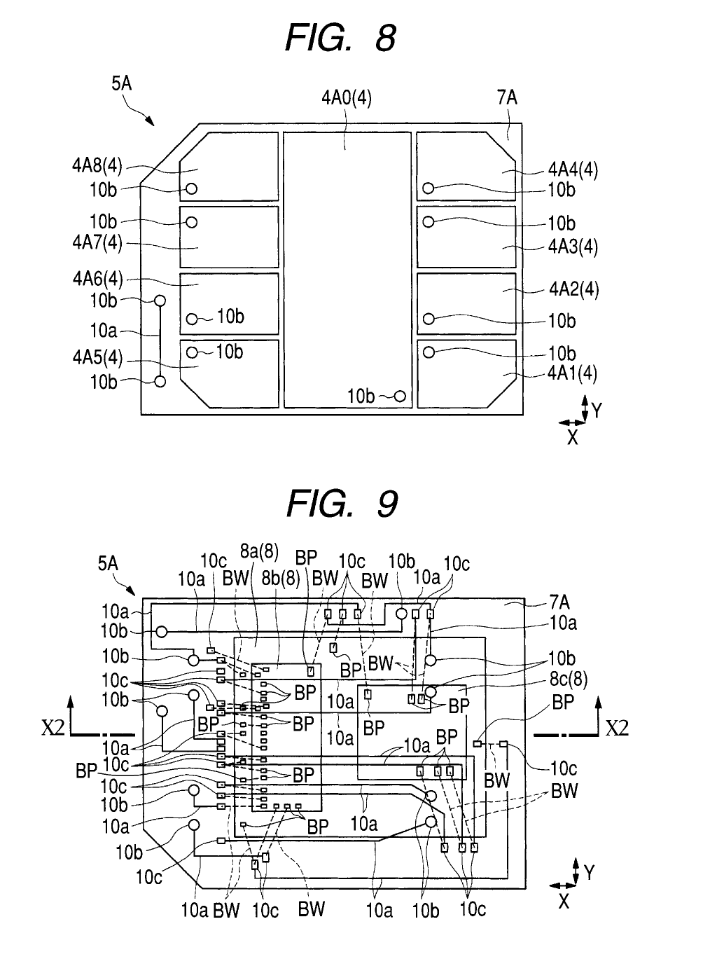

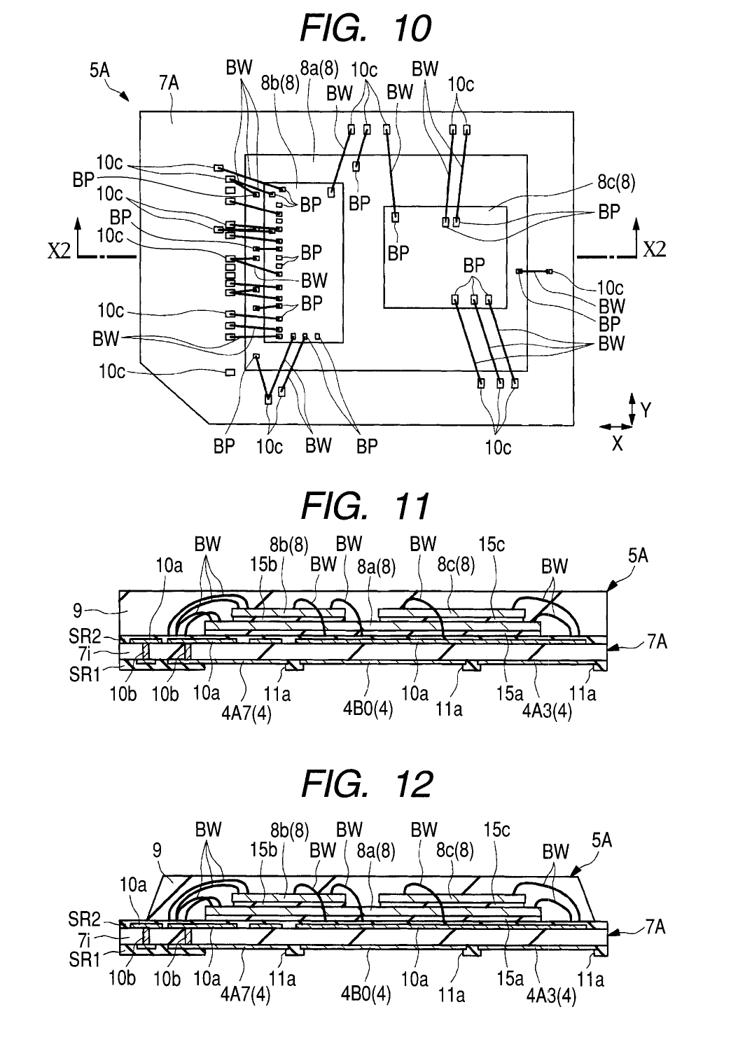

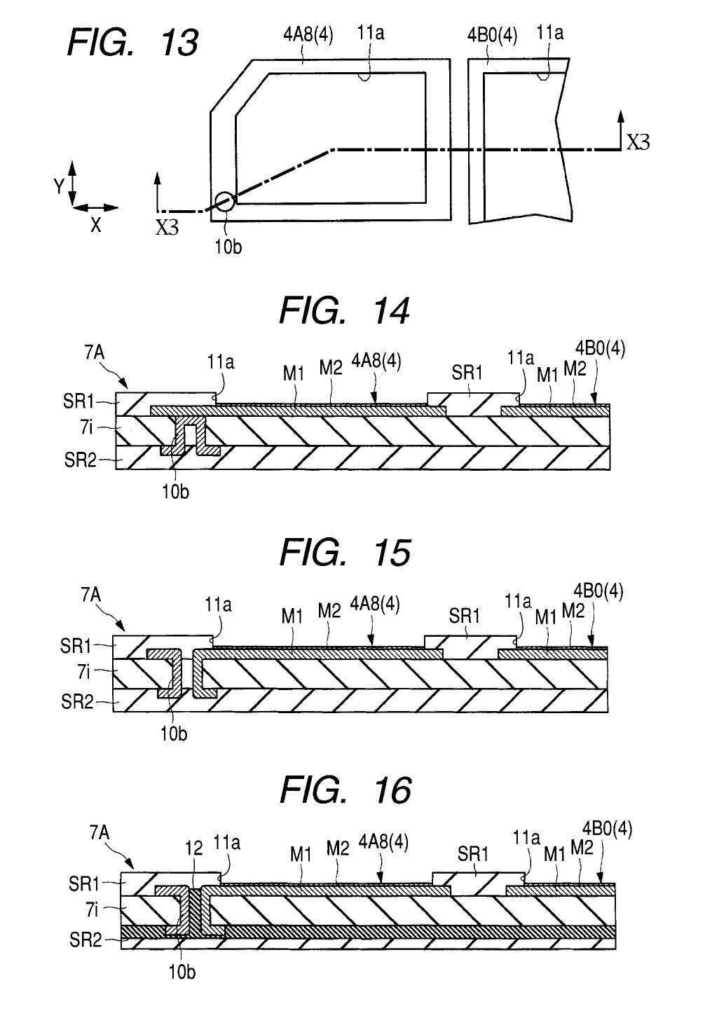

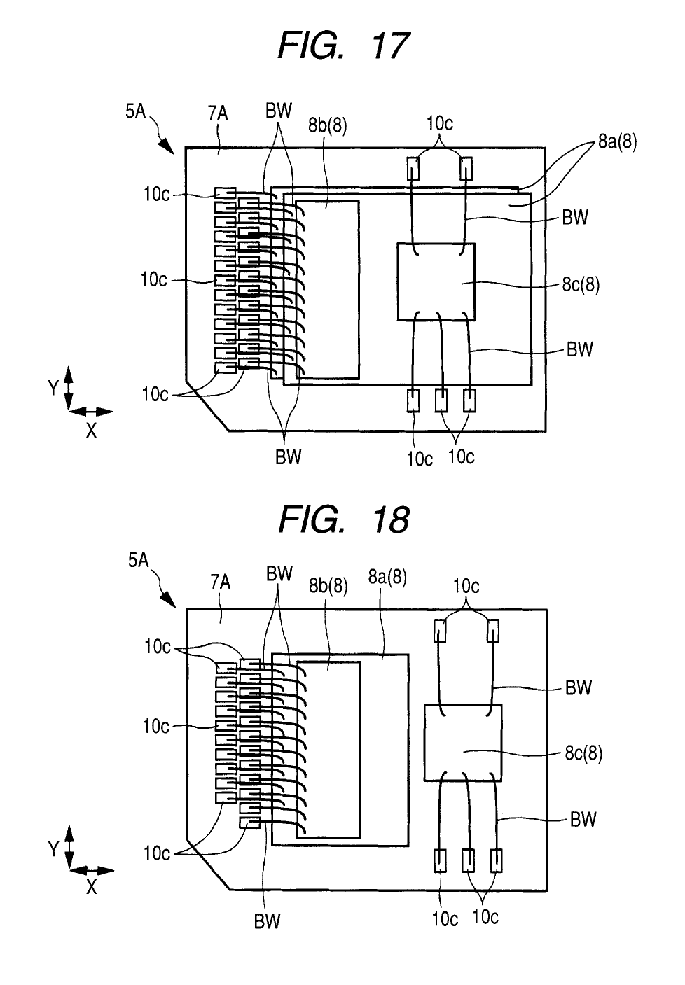

The main chip portion 5A includes a wiring board 7A (board 7A), semiconductor chips 8 (8a to 8c) and a sealing body 9 which seals the semiconductor chips 8. In FIG. 7, for the simplification of explanation, a boundary line between the wiring board 7A and the sealing body 9 is omitted and both are shown in an integrated from as the main chip portion 5A. FIG. 8 is a plan view of the first main surface of the main chip portion 5A, FIGS. 9 and 10 are plan views of a second main surface of the main chip portion 5A shown in FIG. 8, FIG. 11 is a sectional view taken on line X2-X2 in FIGS. 9 and 10, and FIG. 12 is a sectional view taken on line X2-X2 in FIGS. 9 and 10. Further, FIG. 13 is an enlarged plan view of external connecting terminals 4, FIG. 14 is a sectional view taken on line X3-X3 in FIG. 13, FIGS. 15 and 16 are sectional views taken on line X3-X3 in FIG. 13, showing modifications of FIG. 14, and FIGS. 17 to 19 are plan views of a second main surface of the wiring board 7A, showing modifications of the construction of semiconductor chips in the main chip portion 5A. The sealing body 9 is not shown in FIGS. 9, 10 and 14 to 16. In FIG. 9, a part of wiring in the wiring board 7A is shown in see-through manner.

The wiring board 7A in the main chip portion 5A is, for example, a tape board or a printed wiring board having a multi-layer (two-layer) wiring configuration. The wiring board 7A has a first main surface and a second main surface which are positioned on mutually opposite sides in the thickness direction of the wiring board. The first main surface of the wiring board 7A corresponds to the first main surfaces of the IC card 1A and the card chip 3A and the plural external terminals 4 are arranged thereon.

A insulating base 7i of the wiring board 7A is formed using, for example, glass fabric-based epoxy resin or polyimide resin. Wiring (including wiring lines 10a, through holes 10b and electrodes 10c) in the wiring board 7A, as well as die pads and the external connecting terminals 4, each have a main conductor layer M1 formed of copper (Cu) for example and a plating layer M2 formed on an exposed surface. The plating layer M2 is formed by applying gold (Au) plating onto an exposed surface of nickel (Ni) plating as a substrate for example.

Solder resists SR1 and SR2 are formed on the first and second main surfaces of the wiring board 7A. Apertures 11a to which the external connecting terminals are exposed partially are formed in part of the solder resist SR1 formed on the first main surface of the wiring board 7A and the portions exposed from the apertures 11a serve as connection areas of the external connecting terminals 4. Likewise, apertures to which the electrodes 10c are partially exposed are formed in part of the solder resist SR2 formed on the second main surface of the wiring board 7A and the portions exposed from the said apertures serve as connection areas of the electrodes 10c.

The external connecting terminals 4 on the first main surface of the wiring board 7A and the wiring lines 10a on the second main surface of the wiring board 7A are electrically connected with each other through conductor portions (e.g., copper) of the through holes 10b. The through holes 10b are formed within the range of the external connecting terminals 4 and in positions near corners of the external connecting terminals 4 spaced away from the center (connection area) of the external connecting terminals. In the example shown in FIG. 14, a through hole 10b is formed as a hole in which a part of the back side of an external connecting terminal 4 is exposed from the second main surface of the wiring board 7A. In this case, the through hole 10b is not exposed to the main surface (the surface on the connection area side) of the external connecting surface 4.

However, the through hole 10b may be formed as shown in FIG. 15. That is, the through hole 10b may be formed as a hole extending through both first and second main surfaces of the wiring board 7A. In this case, the through hole 10b is exposed to the main surface (the surface on the connection area side) of the external connecting terminal 4. The wiring board having such through holes is easy to fabricate and low in cost as compared with the wiring board having though holes not passing through both first and second main surfaces of the wiring board like that shown in FIG. 15, thus permitting reduction in cost of the card chip 3A. Although the through holes 10b are exposed to the main surfaces (the surface on the connection area side) of the external connecting terminals 4, the exposed surfaces are covered with solder resist SR1 lest concaves and convexes should be formed by the through holes 10b in the connection areas of the external connecting terminals 4. Consequently, connector pins which come into contact with the external connecting pins 4 can be prevented from being chipped or damaged by contact thereof with concaves and convexes in the exposed portions of the through holes 10b. Further, as shown in FIG. 16, concaves and convexes on the exposed surface of each through hole 10b may be diminished by filling insulating paste 12 into the through hole 10b.

A semiconductor chip (second semiconductor chip or memory chip) 8a is mounted on the second main surface of the wiring board 7A in a bonded state to the wiring board through an adhesive layer 15a. The semiconductor chip 8a, which is the largest in planar size, has a substrate of, for example, a single crystal of silicon (Si) and a memory circuit of a memory card circuit is formed on a main surface of the semiconductor chip 8a. The memory circuit is formed by flash memory (non-volatile memory) and electrodes thereof are electrically connected to plural bonding pads (simply “pads” hereinafter) BP which are arranged in longitudinal end portions of the main surface of the semiconductor chip 8a. The pads BP of the semiconductor chip 8a are electrically connected to the electrodes 10c on the second main surface of the wiring board 7A or the pads BP of the semiconductor chip 8b through bonding wires (simply “wires” hereinafter) BW.

A semiconductor chip (third semiconductor chip or control chip) 8b of a rectangular plane having short and long sides is mounted on the main surface (pads BP-formed surface) of the semiconductor chip 8a in a bonded state to the semiconductor chip 8a through an adhesive layer 15b. The semiconductor chip 8b has a substrate of, for example, a single crystal of silicon (Si) and a control circuit for controlling the operation of the memory circuit of the semiconductor chip 8a is formed on a main surface of the semiconductor chip 8b. Electrodes of the control circuit are electrically connected to plural pads BP arranged near the outer periphery of the main surface of the semiconductor chip 8b. The pads BP of the semiconductor chip 8b are electrically connected to the electrodes 10c on the second main surface of the wiring board 7A and the pads BP of the semiconductor chip 8a through wires BW.

A semiconductor chip (first semiconductor chip or IC chip) 8c of a quadrangular plane having four sides is mounted on the main surface of the semiconductor chip 8a in a bonded state to the semiconductor chip 8a through an adhesive layer 15c. The semiconductor chip 8c has a substrate of, for example, a single crystal of silicon (Si) and an IC card microcomputer circuit (IC card circuit) having a security function is formed on a main surface of the semiconductor chip 8c. The IC card microcomputer circuit has the function of a security controller and implements an authentication proving function by an evaluation/authentication organ of ISO/IEC15408 which can be utilized, for example, in electronic payment service. Electrodes of this IC card microcomputer circuit are electrically connected to plural pads BP arranged near the outer periphery of the main surface of the semiconductor chip 8c. The pads BP of the semiconductor chip 8c are electrically connected to the electrodes 10c on the second main surface of the wiring board 7A through wires BW. The wires BW are formed of gold (Au) for example. In FIG. 9, the wires BW are indicated by broken lines to make the drawing easier to see.

Signal wiring of the semiconductor chip 8c formed with the IC card microcomputer is electrically connected to the semiconductor chip 8b formed with the control circuit, provided there also is a case where the signal wiring of the semiconductor chip 8c is connected directly to external connecting terminals 4. Power supply wiring is electrically connected in common to the three semiconductor chips 8a to 8c, but may be separated. The semiconductor chip 8b formed with the control circuit and the semiconductor chip 8a formed with the memory circuit are electrically connected with each other directly or through wiring lines 10a or electrodes 10c on the wiring board 7A. The semiconductor chip 8a and the external connecting terminals 4 may be connected together directly.

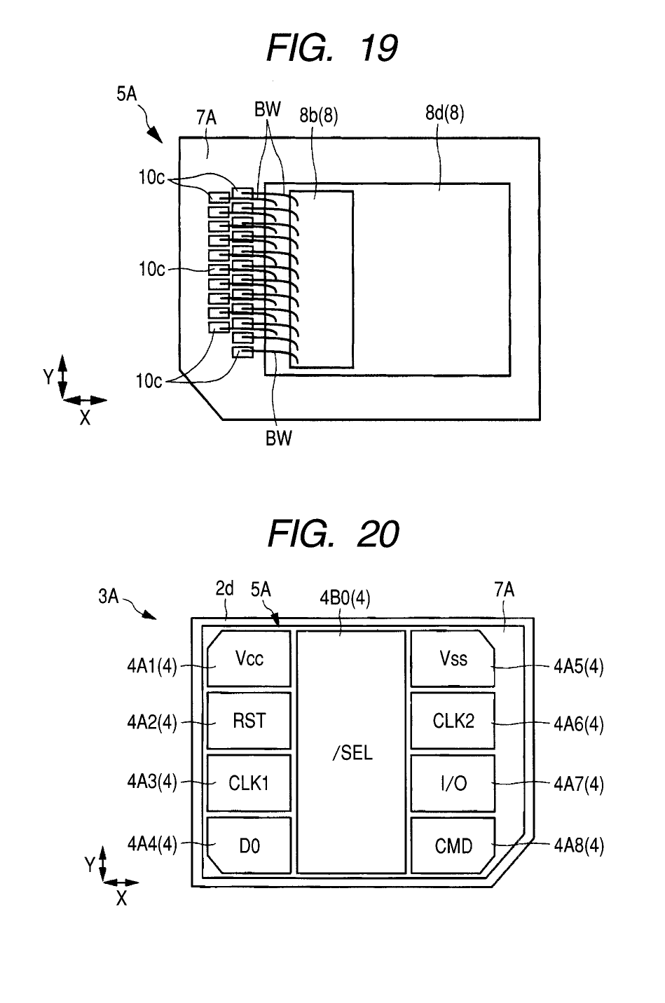

The construction of the semiconductor chips 8 is not limited to the one described above, but various changes may be made. For example, FIG. 17 shows a construction wherein two semiconductor chips 8a each formed with memory circuit are laminated together and the semiconductor chips 8b and 8c are further mounted thereon. In this case, it is possible to increase the memory capacity. FIG. 18 shows a construction wherein the semiconductor chip 8c formed with IC card microcomputer circuit is mounted directly on the second main surface of the wiring board 7A. FIG. 19 shows a construction wherein the aforesaid memory circuit and IC card microcomputer circuit are formed within one semiconductor chip 8d (8). The aforesaid memory circuit, control circuit and IC card microcomputer circuit may be formed within one semiconductor chip 8 and the chip may be disposed on the second main surface of the wiring board 7A. Further, the semiconductor chips 8b and 8c may be integrated into one semiconductor chip.

The sealing body 9 is formed on the second main surface of the wiring board 7A. The semiconductor chips 8 (8a to 8c) and plural wires BW are sealed by the sealing body 9. The sealing body 9 is formed using resin such as, for example, epoxy resin or an ultraviolet (UV) curing resin. FIG. 11 illustrates a case where side faces of the sealing body 9 and side faces of the wiring board 7A are coincident with each other, but there also is such a case as shown in FIG. 12 wherein side faces of the sealing body 9 are retracted from side faces of the wiring board 7A toward the center of the second main surface of the wiring board and are not coincident with side faces of the wiring board.

FIG. 20 shows an example of function (signal) of the external connecting terminals 4 of the card chip 3A.

Of the external connecting terminals 4, the terminals 4A1 to 4A8 are external connecting terminals for interface conforming to ISO/IEC7816-3 as described above. More particularly, the external connecting terminal 4A1 is a terminal for the supply of a high circuit voltage (Vcc), the external connecting terminal 4A2 is a reset signal (RST) terminal, the external connecting terminal 4A3 is a clock signal (CLK1) terminal, and the external connecting terminal 4A4 is a data signal (D0) terminal. Further, the external connecting terminal 4A5 is a terminal for the supply of a reference potential (Vss, GND potential), the external connecting terminal 4A6 is a clock signal (CLK2) terminal, the external connecting terminal 4A7 is a data input/output signal (I/O) terminal, and the external connecting terminal 4A8 is a command signal (CMD) terminal. Among them, the external connecting terminals 4A4, 4A6 and 4A8 are terminals for interface of, for example, one bit bus MMC or HS-MMC (High Speed Multi Media Card). That is, even in the case of external connecting terminals (here the external connecting terminals 4A4, 4A6, 4A8) for interface conforming to ISO7816-3, there are those used as external connecting terminals (or extended terminals) for the transmission and reception of signals in the memory card circuit.

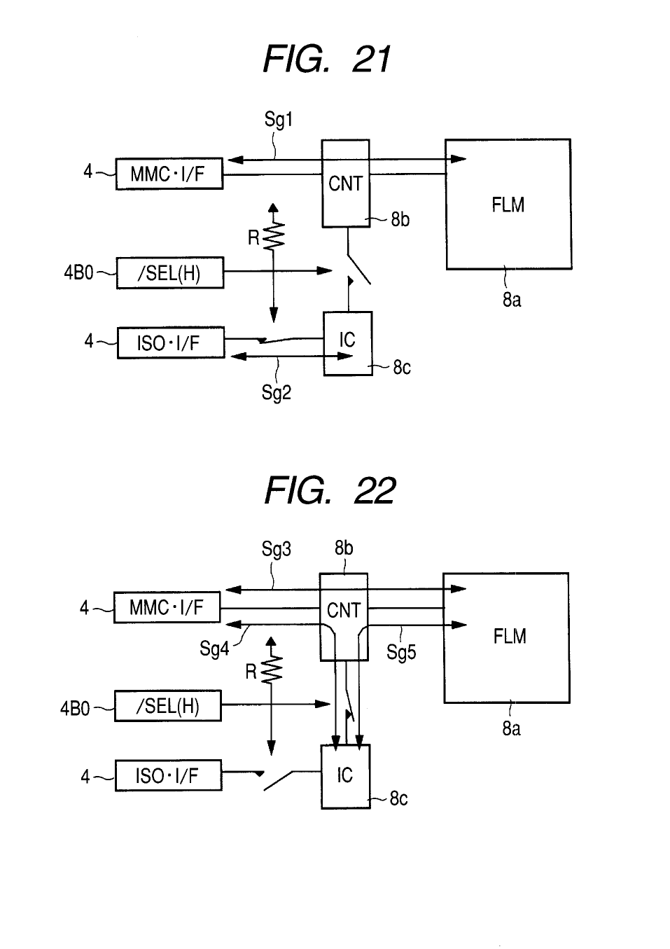

The external connecting terminal 4B0 for extended interface is a mode selection terminal for a signal (/SEL) which makes switching between an independent operation and an interlocked operation of the memory card circuit and the IC card microcomputer circuit. FIGS. 21 and 22 are circuit diagrams for explaining the function of this signal (/SEL). The external connecting terminal 4B0 for the signal (/SEL) pulls up through a resistor R within the card chip 3A and is normally unselected. In this case, as shown in FIG. 21, the signal (/SEL) is set (fixed) high (high potential) and the memory circuit and the IC card microcomputer circuit are adapted to operate each independently through MMC interface (MMC-I/F) and ISO interface (ISO-I/F) respectively, as indicated by signals Sg1 and Sg2. On the other hand, as shown in FIG. 22, when the signal (/SEL) is set (fixed) low (low potential), the ISO interface (ISO-I/F) is separated from the card circuit, and the memory card circuit and the IC card microcomputer circuit operate interlockedly through the MMC interface (MMC-I/F), as indicated by signals Sg3, Sg4 and Sg5. In FIGS. 21 and 22, CNT stands for the control circuit, IC stands for the IC card microcomputer circuit, and FLM stands for the memory circuit. The mode selection described above may be switched over using a command signal (CMD) for the external connecting terminal 4A8. The external connecting terminal 4B0 for the signal (/SEL) may also be constructed so as to accept a command input signal to support a desired mode transition.

Next, a description will be given below about an example of the IC card microcomputer circuit and control circuit both described above.

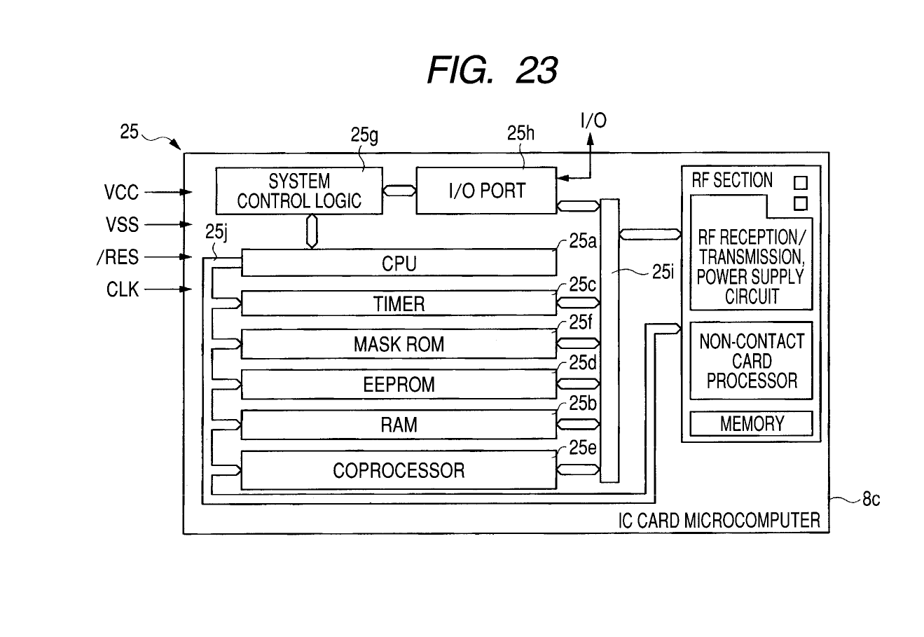

FIG. 23 shows an example of the IC card microcomputer circuit formed within the semiconductor chip 8c. An IC card microcomputer circuit 25 (IC) includes CPU 25a, RAM 25b as work RAM, timer 25c, EEPROM 25d, coprocessor unit 25e, mask ROM 25f, system control logic 25g, input/output port (I/O port) 25h, data bus 25i and address bus 25j.

The mask ROM 25f is utilized for the storage of operation programs (e.g., encrypting program, decoding program, interface control program) for CPU 25a and data. The RAM 25b is used as a work area or a temporary data storage area and is constituted, for example, by SRAM or DRAM. When an IC card command is fed to the I/O port 25h, the system controller 25g decodes it and causes the CPU 25a to execute a processing program necessary for execution of that command. The CPU 25a makes access to the mask ROM 25f in accordance with an address instructed by the system control logic 25g, fetches an instruction, then decodes the fetched instruction, and performs operand fetch or data calculation on the basis of the result of the decoding. In accordance with control performed by CPU 25a the coprocessor unit 25e performs a remainder calculation processing in RSA or elliptic curve cipher calculation.

The I/O port 25h has a one-bit input/output terminal I/O and is used for both input and output of data and input of an external interrupt signal. The I/O port 25h is connected to the data bus 25i, and the CPU 25a, RAM 25b, timer 25c, EEPROM 25d and coprocessor unit 25e are electrically connected to the data bus 25i.

The system control logic 25g performs operation mode control and interruption control for the IC card microcomputer circuit 25 and has a random-number generation logic utilized for the generation of a cipher key. When a reset operation is instructed by a reset signal /RES, the interior of the IC card microcomputer circuit 25 is initialized and the CPU 25a starts execution of the instruction, beginning with the head address of program in EEPROM 25d. The IC card microcomputer circuit 25 operates in synchronism with a clock signal CLK.

The EEPROM 25d permits electric erase and write processings and is used as an area for the storage of data such as ID (Identification) information for specifying an individual and authentication certificate. A flash memory or a ferroelectric memory may be used instead of EEPROM 25d. The IC card microcomputer circuit 25 supports a contact interface which uses an external terminal for interface with the exterior.

On the main surface of the semiconductor chip 8b is formed an interface controller circuit for example. The interface controller circuit has a function of controlling both external interface operation and memory interface operation in accordance with a control mode based on an external command or a setting predetermined in the interior. The interface control mode which the card chip 3A possesses is, for example, MMC (including RS-MMC) mode. For example, the interface controller circuit functions to recognize a memory card interface control mode in accordance with the state of a command or bus for exchange communication with the exterior through an external connecting terminal, switch over from one bus width to another in accordance with the recognized memory card interface control mode, and change the data format in accordance with the recognized memory card interface control mode. Other functions include, for example, power ON reset function, interface control function of controlling interface with the IC card microcomputer circuit in the semiconductor chip 8c, interface control function of controlling interface with the memory circuit in the semiconductor chip 8a, and changing of the supply voltage.

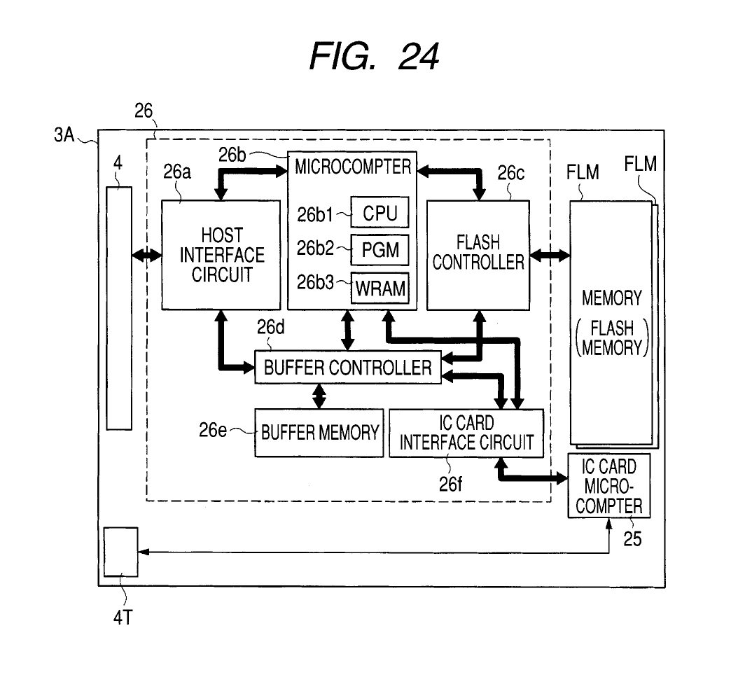

FIG. 24 shows an example of the interface controller circuit (control circuit) 26 described above. A memory circuit FLM shown in FIG. 24 represents the memory circuit formed in the semiconductor chip 8a.

The interface controller circuit 26 includes a host interface circuit 26a, a microcomputer 26b, a flash controller 26c, a buffer controller 26d, a buffer memory 26e and an interface circuit 26f for IC card. The buffer memory 26e is constituted by DRAM or SRAM. The IC card microcomputer circuit 25 is electrically connected to the IC card interface circuit 26f. The microcomputer 26b includes a CPU (central processing unit) 26b1, a program memory (PGM) 26b2 possessing operation programs of CPU 26b1, and a work memory (WRAM) 26b3 used in a work area of CPU 26b1. Control programs in the interface control mode corresponding to the foregoing SD card, MMC (including RS-MMC) and HS-MMC are stored in the program memory 26b2.

Upon detection of issuance of a memory card initialize command, the host interface circuit 26a performs an interrupt and makes it possible to execute a control program in the interface control mode corresponding to the microcomputer 26b. The microcomputer 26b executes the control program and thereby controls the external interface operation performed by the host interface circuit 26a. The microcomputer 26b controls access (write, erase and read operations) to the memory circuit FLM by the flash controller 26c and data management and controls the change of format between the data format peculiar to the memory card and a common data format for memory which is performed by the buffer controller 26d. Data read from the memory circuit FLM or data to be written to the same memory circuit are stored temporarily in the buffer memory 26e. The flash controller 26c causes the memory circuit FLM to operate as a hard disk compatible file memory and manages data sector by sector. The flash controller 26c is provided with an ECC circuit (not shown) to add ECC code at the time of storing data to the memory circuit FLM and performs an error detection/correction processing for read data with use of the ECC code. The reference numeral 4T stands for an antenna terminal or an input/output terminal for a non-contact card.

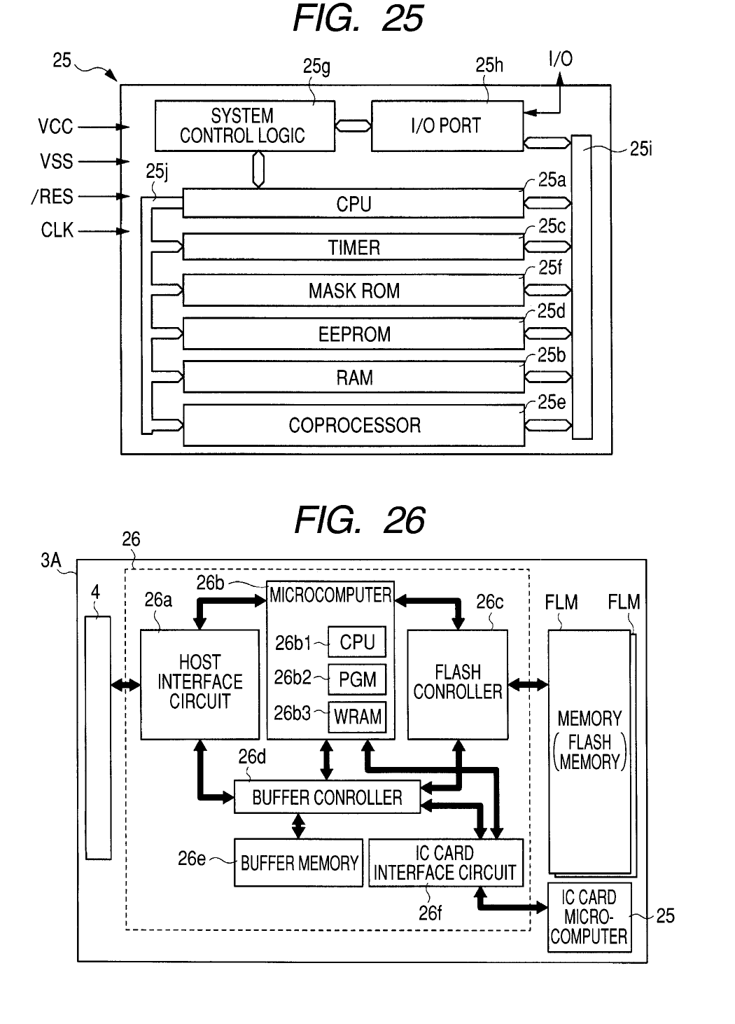

FIGS. 25 and 26 show another example of the IC card microcomputer circuit and the control circuit described above. This example is different from the example shown in FIGS. 23 and 24 in that a power supply terminal for the supply of a low supply voltage is disposed in the portion corresponding to the antenna terminal 4T shown in FIG. 24 and that there is neither the antenna terminal 4T shown in FIG. 24 nor a circuit for non-contact interface.

### Second Embodiment

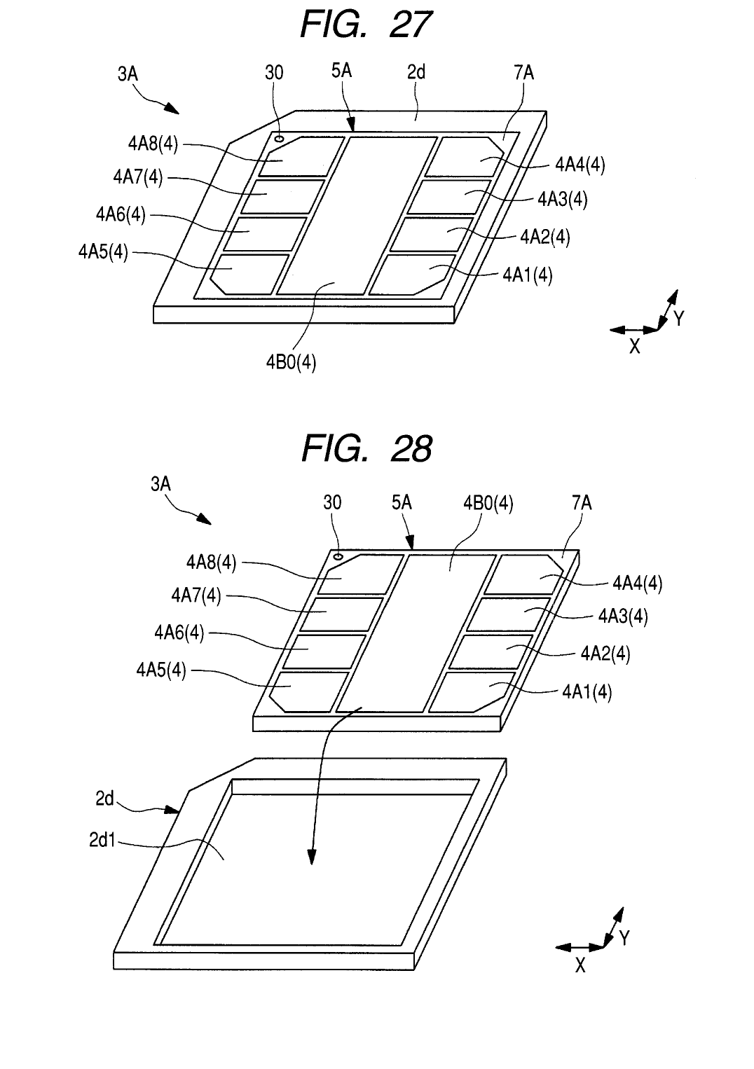

FIG. 27 is a perspective view of a first main surface side of a card chip 3A of an IC card 1A according to a second embodiment of the present invention and FIG. 28 is an exploded perspective view of the card chip 3A shown in FIG. 27. A perspective view of a second main surface side of the card chip 3A shown in FIG. 27 is omitted because it is the same as FIG. 5.

In this second embodiment, a planar shape of a wiring board 7A of a main chip portion 5A of the card chip 3A is different from that in the first embodiment. More particularly, in this second embodiment, a large chamfered portion is not formed at a corner of the wiring board 7A and a planar shape of the wiring board 7A is square. In this case, a cutting process for forming a chamfered portion at one corner of the wiring board 7A can be omitted and therefore it is possible to simplify the manufacturing process for the wiring board 7A. A planar shape of a recess 2d of a cap 2d is also square to match the planar shape of the wiring board 7A. Further, an alignment mark 30 is formed near a corner of a first main surface of the wiring board 7A. In this second embodiment, since the wiring board 7A is square in plan, there is a possibility that the wiring board 7A may be inserted in a wrong direction when fitting it into the recess 2d1 of the cap 2d. The alignment mark 30 is a mark for preventing the occurrence of such an inconvenience. That is, with the alignment mark 30, it is possible to prevent the wiring board 7A from being inserted in a wrong direction. Other constructional points are the same as in the first embodiment.

### Third Embodiment

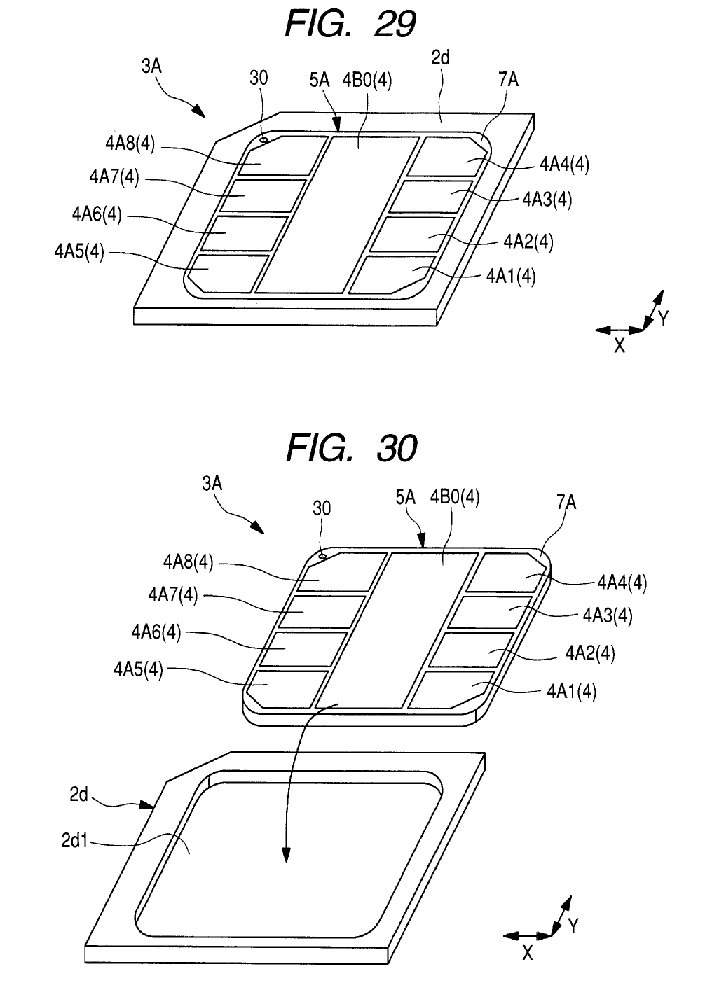

FIG. 29 is a perspective view of a first main surface side of a card chip 3A of an IC card 1A according to a third embodiment of the present invention and FIG. 30 is an exploded perspective view of the card chip 3A shown in FIG. 29. A perspective view of a second main surface side of the card chip 3A shown in FIG. 29 is omitted because it is the same as FIG. 5.

In this third embodiment, a wiring board 7A is formed in a square shape in plan having round corners. That is, four corners of the wiring board 7A are tapered as rounded corners. A recess 2d1 of a cap 2d is also formed in a square shape in plan having round corners to match the planar shape of the wiring board 7A. The recess 2d1 is formed using a machining tool such as, for example, an end mill. Also in this third embodiment, an alignment mark 30 is formed near a corner of a first main surface of the wiring board 7A. With the alignment mark 30, it is possible to prevent the wiring board 7A from being inserted in a wrong direction. Other constructional points are the same as in the first embodiment.

### Fourth Embodiment

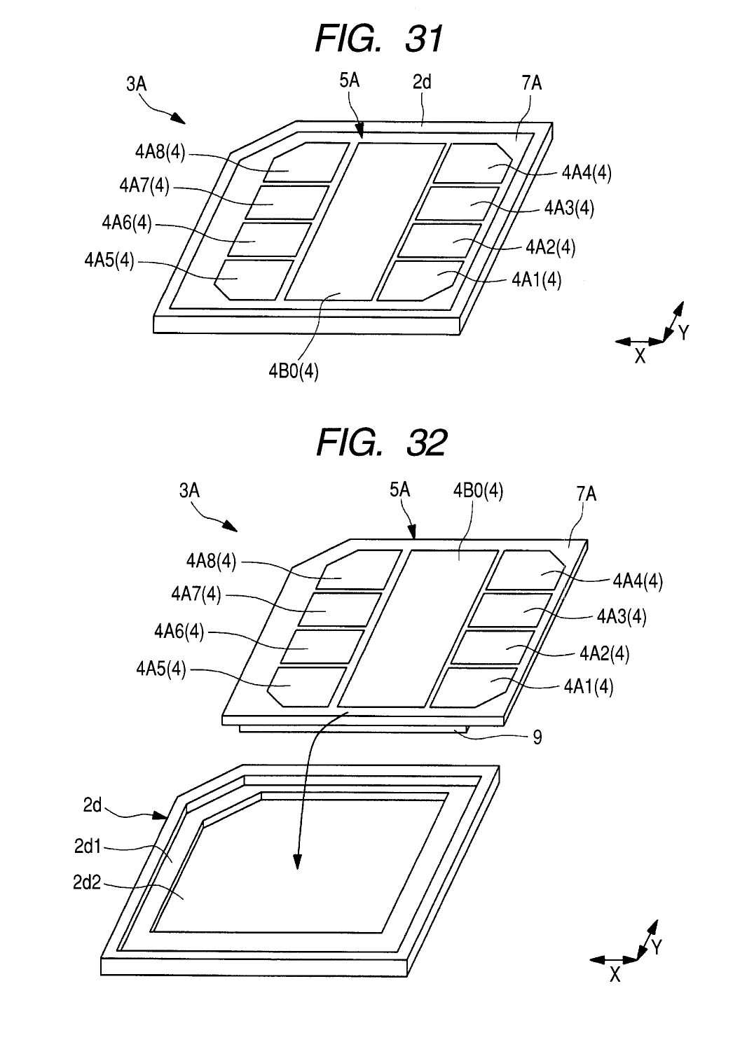

FIG. 31 is a perspective view of a first main surface side of a card chip 3A of an IC card 1A according to a fourth embodiment of the present invention and FIG. 32 is an exploded perspective view of the card chip 3A shown in FIG. 31. A perspective view of a second main surface side of the card chip 3A shown in FIG. 31 is omitted because it is the same as FIG. 5.

In this fourth embodiment, a recess of a cap 2d which accommodates a main chip portion 5A is formed in two stages. More specifically, in this forth embodiment, a deeper recess 2d2 is formed in the bottom of a recess 2d1 of the cap 2d. A planar size of the recess 2d2 is smaller than that of the recess 2d1, but a planar shape of the recess 2d2 is analogous to that of the recess 2d1.

A sealing body 9 of the same construction as that of FIG. 12 described in the first embodiment is formed on a second main surface of a wiring board 7A. The wiring board 7A is fitted in the recess 2d1 and the sealing body 9 on the second main surface of the wiring board 7A is fitted in the recess 2d2. Other constructional points are the same as in the first embodiment.

### Fifth Embodiment

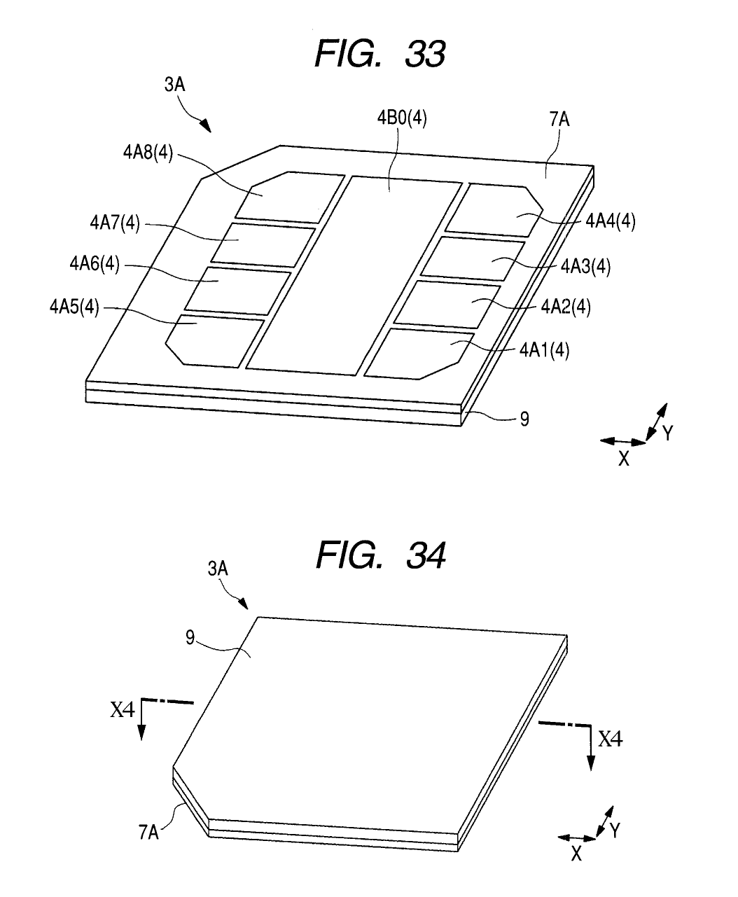

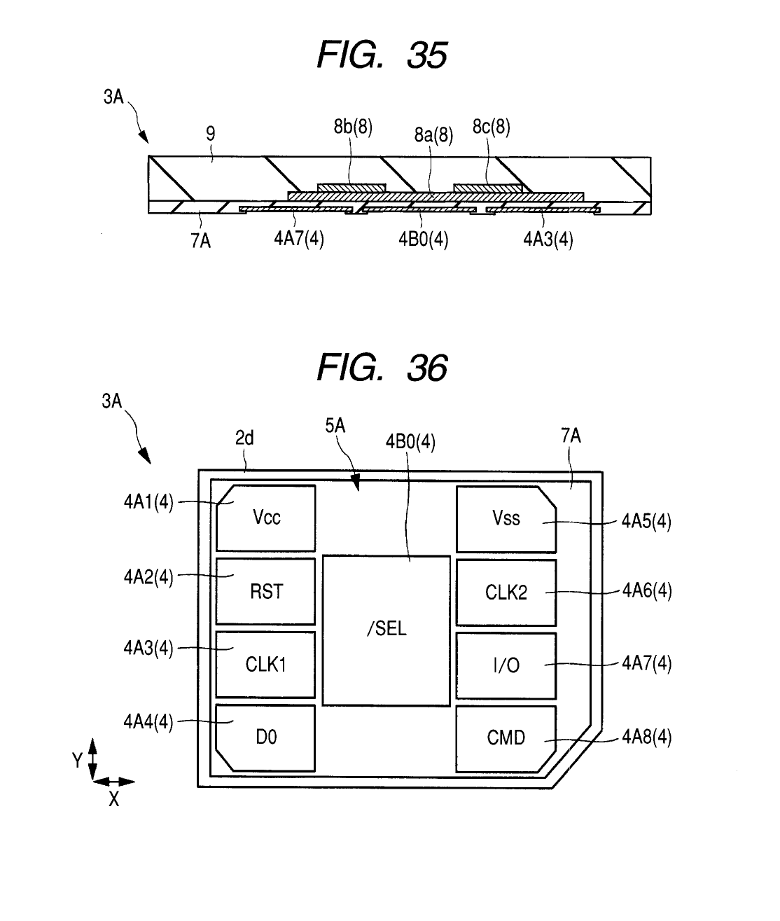

FIG. 33 is a perspective view of a first main surface side of a card chip 3A according to a fifth embodiment of the present invention, FIG. 34 is a perspective view of a second main surface side of the card chip 3A shown in FIG. 33, and FIG. 35 is a sectional view taken on line X4-X4 in FIG. 34.

In the card chip 3A of this fifth embodiment, a cap 2d is not used, but a part of the outline of the card ship 3A is formed by a sealing body 9. In this case, since there is no thickness of the cap 2d, it is possible to increase an allowance for thickness of the sealing body 9. Accordingly, a larger number of semiconductor chips 8 can be stacked on the second main surface of the wiring board 7A. For example, a larger number of semiconductor chips 8a for the memory circuit can be stacked, whereby it is possible to increase the memory capacity. Moreover, since the restriction on the height of wires BW can be eased, it is possible to facilitate assembly of the card chip 3A. In the case of the card chip 3A having the cap 2d, it is necessary that the cap 2d be made as thin as possible in order to ensure the thickness of the sealing body 9, with a consequent likelihood of occurrence of a problem in point of strength. In this fifth embodiment, such a problem does not occur because the cap 2d is not used. Other constructional points are the same as in the first embodiment. The sealing body 9 and the wiring board 7A are harder than the cap 2d, so if they come into contact with any other thing, there is a possibility that the other thing may be damaged. As a countermeasure to this point it is preferable in this fifth embodiment that the corners of the card chip 3A (the sealing body 9 and the wiring board 7A) be tapered in a rounded shape.

### Sixth Embodiment

FIG. 36 is a plan view of a first main surface of a card chip 3A of an IC card 1A according to a sixth embodiment of the present invention. A perspective view of a second main surface side of the card chip 3A shown in FIG. 36 is omitted because it is the same as FIG. 5.

In this sixth embodiment, an external connecting terminal 4B0 for extended interface is smaller in area than in the first embodiment. More specifically, the length in the second direction Y of the external connecting terminal 4B0 is only about the total length of two external connecting terminals 4 arranged side by side in the second direction Y. In the illustrated example the external connecting terminal 4B0 is located nearly centrally in the second direction Y, but no limitation is made thereto and the external connecting terminal 4B0 may be disposed offset at one of both ends in the second direction Y.

For example, in the case where a planar position of a connector pin connected to the external connecting terminal 4B0 differs according to various companies, it is preferable that the external connecting terminal 4B0 extend from end to end in the second direction Y as in the first embodiment. This is because it is possible to cope with connector pin layouts of various companies flexibly. On the other hand, in the case where the connector pin position is predetermined, an external connecting terminal 4B0 of a small size may be disposed in the portion for contact with the connector pin as in this sixth embodiment. In this case, empty areas free of the external connecting terminal 4B0 can be formed in the portion located between the rows of external connecting terminals 4A1 to 4A4 and 4A5 to 4A8. By disposing other external connecting terminals for extended interface in the empty areas it is possible to further improve the function of the card chip 3A.

### Seventh Embodiment

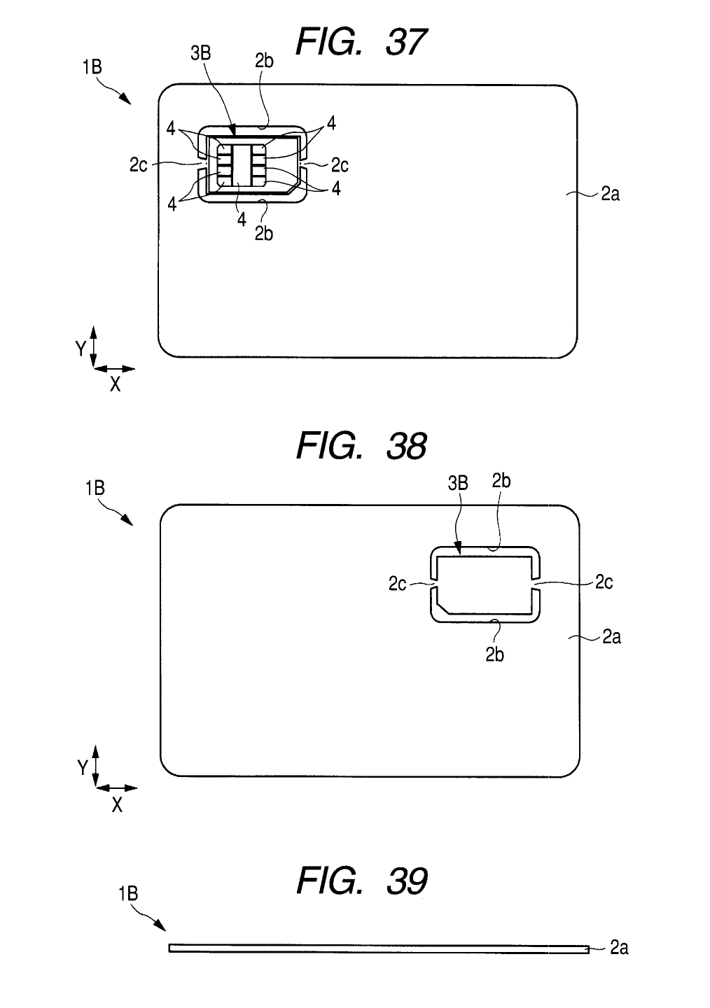

FIG. 37 is an entire plan view of a first main surface of an IC card 1B having a semiconductor device according to a seventh embodiment of the present invention, FIG. 38 is an entire plan view of a second main surface as a back side of the first main surface of the IC card 1B shown in FIG. 37, and FIG. 39 is a side view of the IC card 1B shown in FIGS. 37 and 38.

The IC card 1B is, for example, an SIM card or UIM card of a standard size. The outline of the IC card 1B is generally rectangular and outline dimensions thereof are, for example, about 85.6 mm×54 mm×0.76 mm.

An aperture 2b is formed in a corner position spaced away from the center of a card frame 2a of the IC card 1B and a card chip 3B is fitted in the aperture 2b snugly in a state in which it is joined to the card frame 2a and supported by a support portion 2c. The construction of the card chip 3B is the same as that of the card chip 3A of the first embodiment except that the size thereof is larger than that of the card chip 3A.

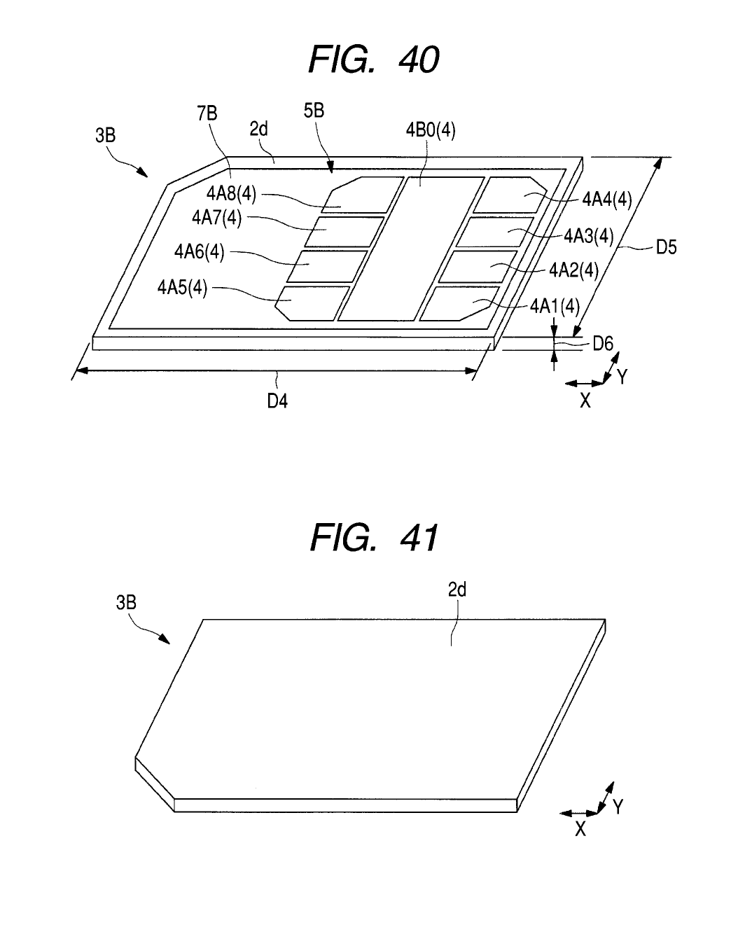

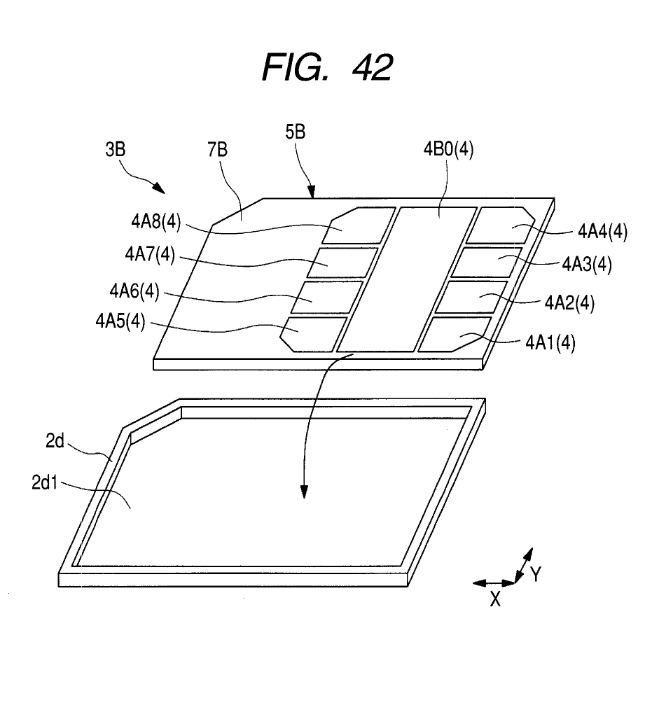

FIG. 40 is a perspective view of a first main surface of the card chip 3B shown in FIGS. 37 and 38, FIG. 41 is a perspective view of a second main surface side of the card chip 3B shown in FIG. 40, and FIG. 42 is an exploded perspective view of the card chip 3B shown in FIG. 40.

For example, the outline of the card chip 3B is in a quadrangular shape in conformity with the outline standard of SIM card or UIM card of the standard size. One corner of a front side of the card chip 3B is largely chamfered for index. Outline dimensions (D4×D5×D6) of the card chip 3B are, for example, about 25 mm×15 mm×0.76 mm.

As in the first embodiment, eight external connecting terminals (ISO7816 terminals) 4A1 to 4A8 (4) for interface conforming to ISO/IEC7816-3 which is for IC card function and one external connecting terminal (non-ISO7816 terminal, extended terminal) 4B0 (4) for extended interface not conforming to ISO/IEC7816-3 are formed on the first main surface of the card chip 3B (corresponding to the first main surface of the IC card 1A) in an exposed state to the exterior. The constructions of the external connecting terminals 4A1 to 4A8 and 4B0 (4) are the same as in the first embodiment and therefore an explanation thereof is here omitted. Also in this seventh embodiment the external connecting terminal 4B0 (4) for extended interface is disposed in the area between rows of the external connecting terminals 4A1 to 4A4 and 4A5 to 4A8 conforming to ISO/IEC7816-3, whereby the memory card function and other electronic circuit functions can be incorporated in the card chip 3B and hence it is possible to improve the function of the card chip 3B.

A planar size of a main chip portion 5B and a wiring substrate 7B in the card chip 3B is a little smaller than that of the card chip 3B (the widths of edges of a cap 2d remained on the first main surface of the card chip 3B are designed so as to be equal throughout the whole periphery and are, for example, about 0.45 mm). Further, a planar shape of the main chip portion 5B and the wiring board 7B is analogous to that of the card chip 3B and one corner on the front side thereof is largely chamfered. The construction of the main chip portion 5B and the wiring board 7B is the same as that of the main chip portion 5A and the wiring board 7A described in the first embodiment and therefore an explanation thereof is here omitted.

The cap 2d and a recess 2d1 formed in a first main surface thereof are also merely larger in planar size than in the first embodiment and other constructional points thereof are the same as in the first embodiment. Further, the construction of the card chip 3B is the same as that of the card chip 3A described in the first embodiment except that the size thereof is different, and therefore an explanation thereof is here omitted. The section of the card chip 3B is also the same as that shown in FIG. 6 except that the size thereof is different.

Also in the case of the card chip 3B of the standard size according to this seventh embodiment it is possible to adopt the constructions shown in FIGS. 27, 28, 29, 30, 31 and 32.

### Eighth Embodiment

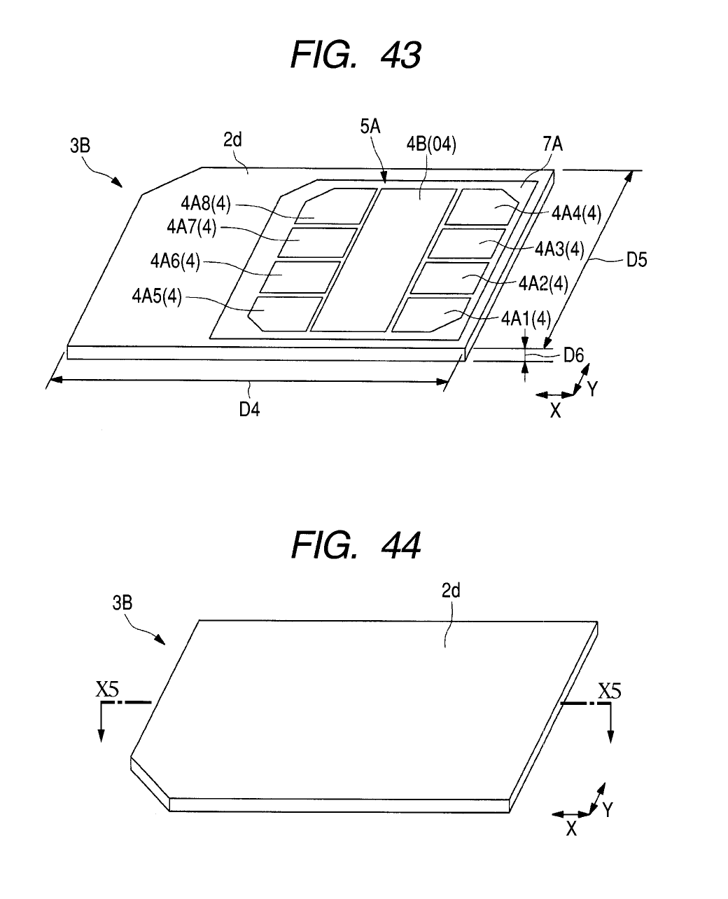

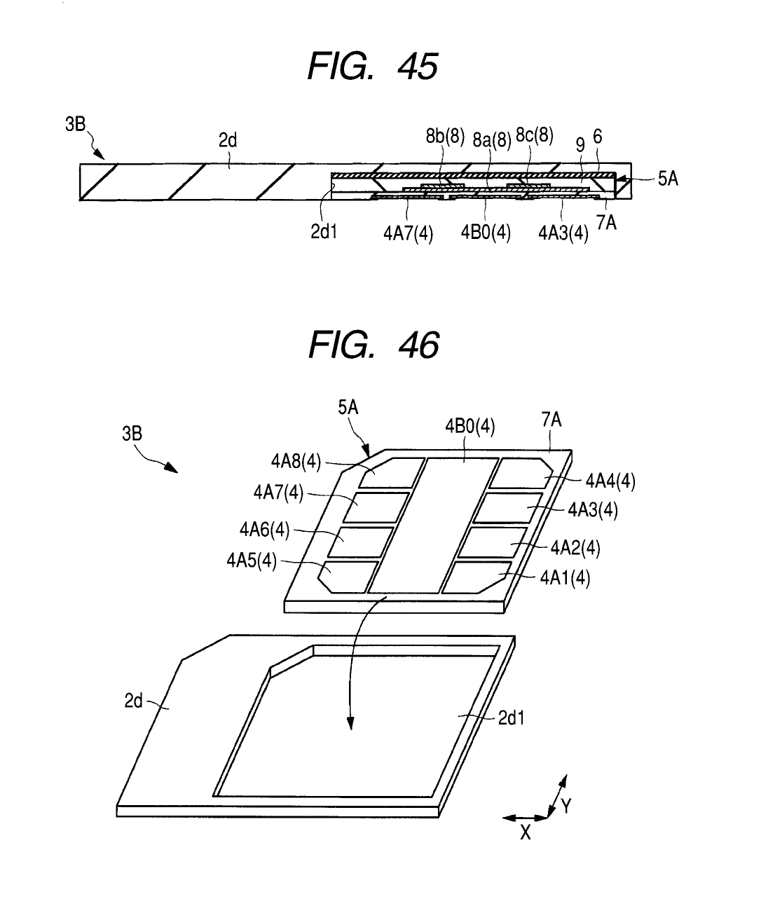

FIG. 43 is a perspective view of a first main surface side of a card chip 3B of an IC card 1B having a semiconductor device according to an eighth embodiment of the present invention, FIG. 44 is a perspective view of a second main surface side as a back side of the first main surface of the card chip 3B shown in FIG. 43, FIG. 45 is a sectional view taken on line X5-X5 in FIG. 44, and FIG. 46 is an exploded perspective view of the card chip 3B shown in FIG. 43.

In this eighth embodiment, the main chip portion 5A and the wiring board 7A for the card chip 3A of mini size described in the first embodiment are used for the card chip 3B of standard size. Other constructional points are the same as in the seventh embodiment. An IC card 1B according to this eighth embodiment is the same as that shown in FIGS. 37 to 39 except that the size of its main chip portion 5A is different.

In this eighth embodiment, since the main chip portion 5A and wiring board 7A which are small in area can be used for the IC card 1B and card chip 3B of standard size, it is possible to reduce the cost of the IC card 1B and that of the card chip 3B. It is also possible to attain the reduction in weight of the IC card 1B and card chip 3B.

Moreover, since the card chip 3A of mini size and the card chip 3B of standard size can share the main chip portion 5A and the wring board 7A, it is possible to shorten the time required for fabrication of the IC cards 1A, 1B and the card chips 3A, 3B. It is also possible to reduce the manufacturing cost of the IC cards 1A, 1B and the card chips 3A, 3B.

Further, it is possible to increase the region (area) of the cap 2d in the first main surface of the card chip 3B. That is, it is possible to increase the area of the cap 2d which permits easy printing or the like. Consequently, the ability to display pictures, figures and symbols on the IC cards 1A, 1B and the card chips 3A, 3B in a visible state can be improved.

Also in the case of the card chip 3B of standard size according to this eighth embodiment it is possible to adopt the constructions shown in FIGS. 27, 28, 29, 30, 31 and 32.

### Ninth Embodiment

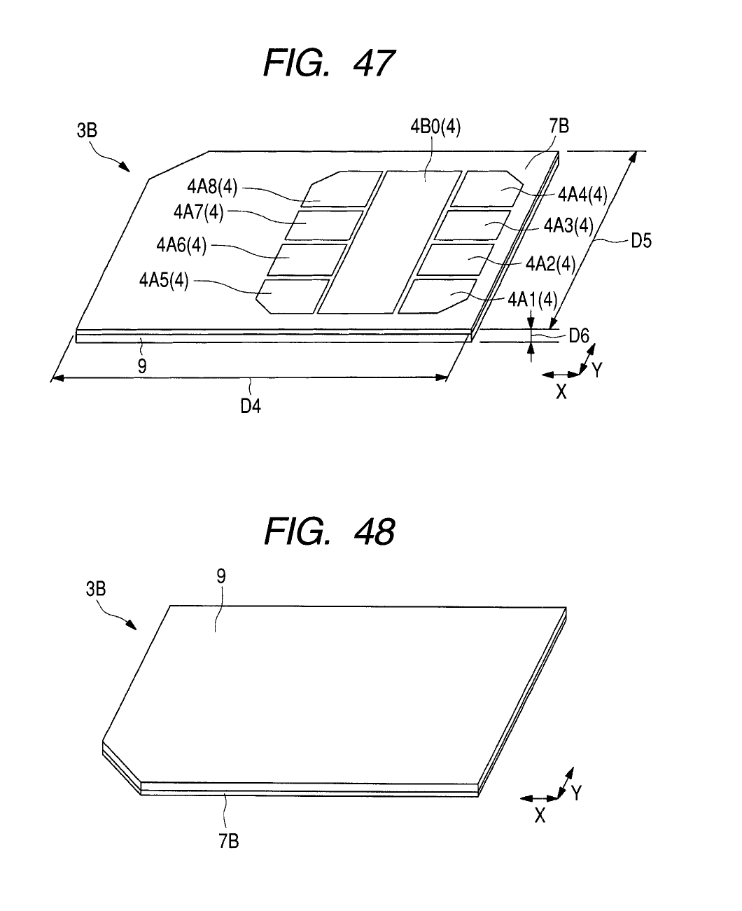

FIG. 47 is a perspective view of a first main surface side of a card chip 3B according to a ninth embodiment of the present invention and FIG. 48 is a perspective view of a second main surface side of the card chip 3B shown in FIG. 47.

The card chip 3B does not have a cap 2d and a part of the outline of the card chip 3B is formed by a sealing body 9. That is, the card chip 3B of this ninth embodiment is the same as the card chip 3A (wiring board 7A) described in the fifth embodiment except that the size thereof is different. Therefore, also in this ninth embodiment it is possible to obtain the same effect as in the fifth embodiment. A sectional view of the card chip 3B shown in FIGS. 47 and 48 is the same as FIG. 35 except that the size thereof is different and is therefore omitted.

### Tenth Embodiment

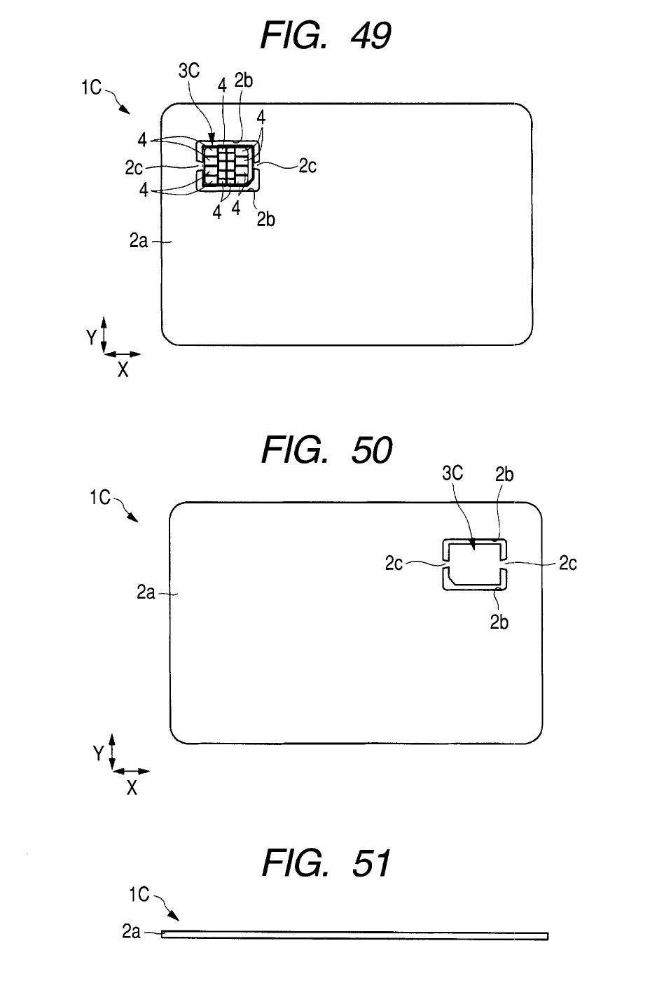

FIG. 49 is an entire plan view of a first main surface of an IC card 1C having a semiconductor device according to a tenth embodiment of the present invention, FIG. 50 is an entire plan view of a second main surface as a back side of the first main surface of the IC card 1C shown in FIG. 49, and FIG. 51 is a side view of the IC card 1C shown in FIG. 50.

The IC card 1C is, for example, a mini-size UICC, SIM card or UIM card. The outline and size of the IC card 1C are the same as in the first embodiment.

An aperture 2b is formed in a corner position spaced away from the center of a card frame 2a of the IC card 1C and a card chip 3C is fitted snugly in a state in which it is joined to the card frame 2a and supported by a support portion 2c. The construction of the card chip 3C is the same as that of the card chip 3A in the first embodiment except that that construction of plural external terminals 4 arranged on a first main surface of the card chip 3C is different from that of the card chip 3A.

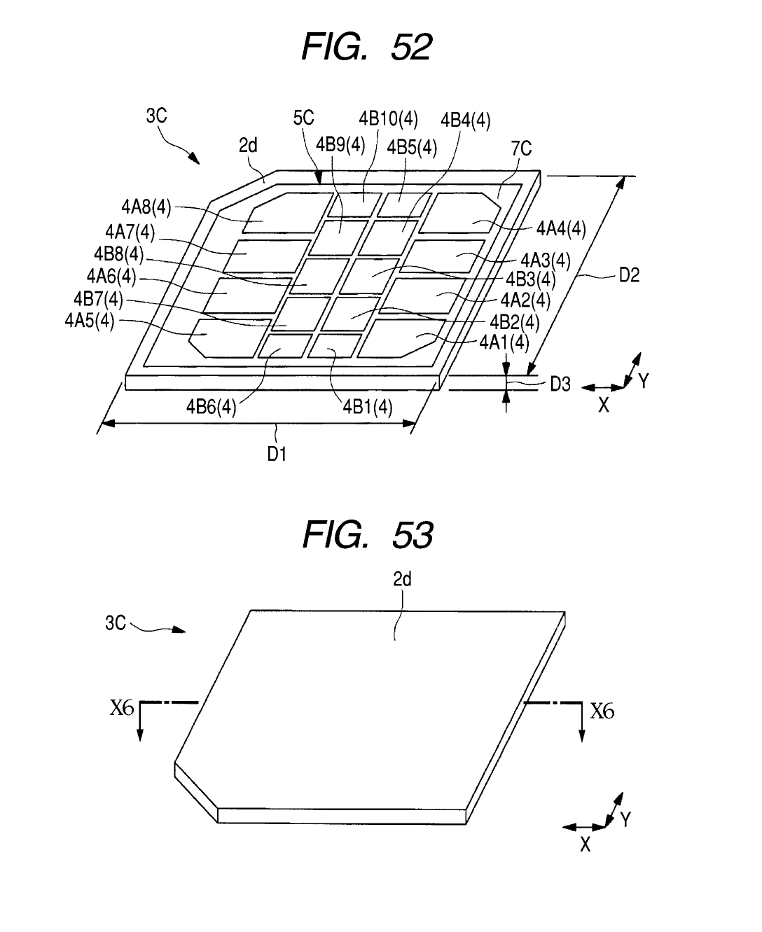

FIG. 52 is a perspective view of the first main surface side of the cad chip 3C shown in FIGS. 49 and 50, FIG. 53 is a perspective view of a second main surface side of the card chip 3C shown in FIGS. 49 and 50, FIG. 54 is a sectional view taken on line X6-X6 in FIG. 53, and FIG. 55 is an exploded perspective view of the card chip 3C shown in FIGS. 49 and 50.

The outline of the card chip 3C is formed for example in a square shape in conformity with the outline standard of mini-size SIM card and mini UIM card and one corner on its front side is largely chamfered for index. Outline dimensions (D1×D2×D3) of the card chip 3C are the same as that of the card chip 3A described in the first embodiment.

Eight external connecting terminals (ISO7816 terminals) 4A1 to 4A8 (4) for interface conforming to ISO/IEC7816-3 which is for IC card function and ten external connecting terminals (non-ISO7816 terminals, extended terminals) 4B1 to 4B10 (4) for extended interface not conforming to ISO/IEC7816-3 are arranged on the first main surface of the card chip 3C (the first main surface side of the IC card 1C) in an exposed state to the exterior. The external connecting terminals 4B1 to 4B10 are arranged in the area sandwiched in between two rows of the external connecting terminals 4A1 to 4A4 and 4A5 to 4A8.

By thus arranging the external connecting terminals 4B1 to 4B10 (4) for extended interface in the area between the rows of the external connecting terminals 4A1 to 4A4 and 4A5 to 4A8 conforming to the ISO/IEC7816-3, the memory card function and other electronic circuit functions can be incorporated into the cad chip 3C and hence it is possible to improve the function of the card chip 3C.

The card chip 3C includes a main chip portion 5C and a cap 2d. The construction of the main chip portion 5C is the same as that of the main chip portion 5A except that the construction of the external connecting terminals 4 arranged on the first main surface of the main chip portion is different from that of the main chip portion 5A in the first embodiment.

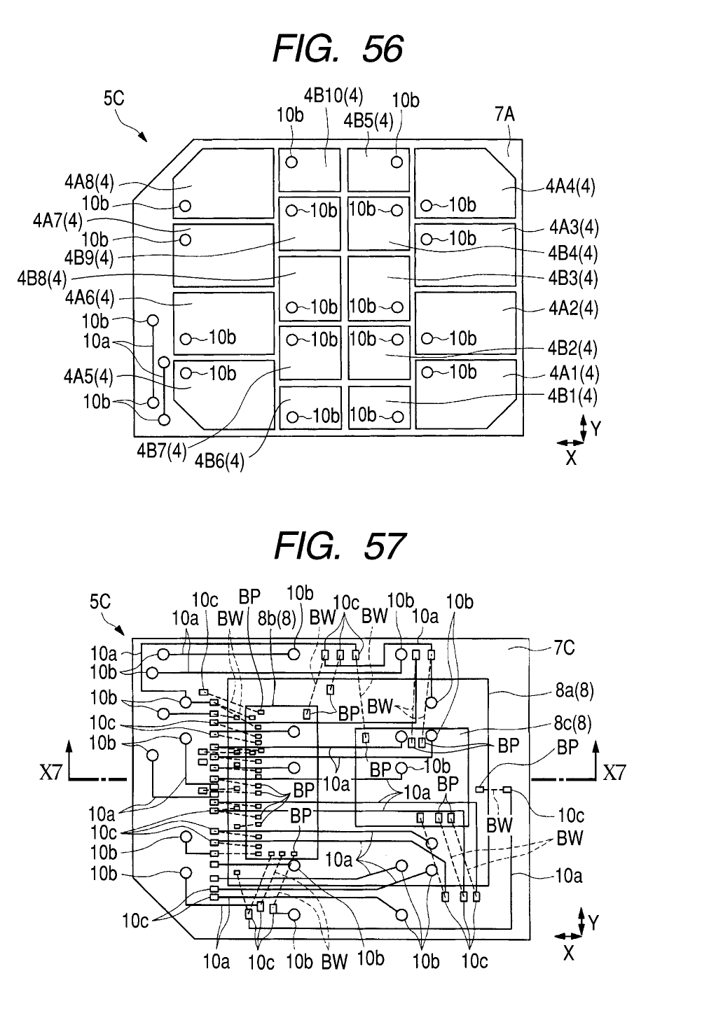

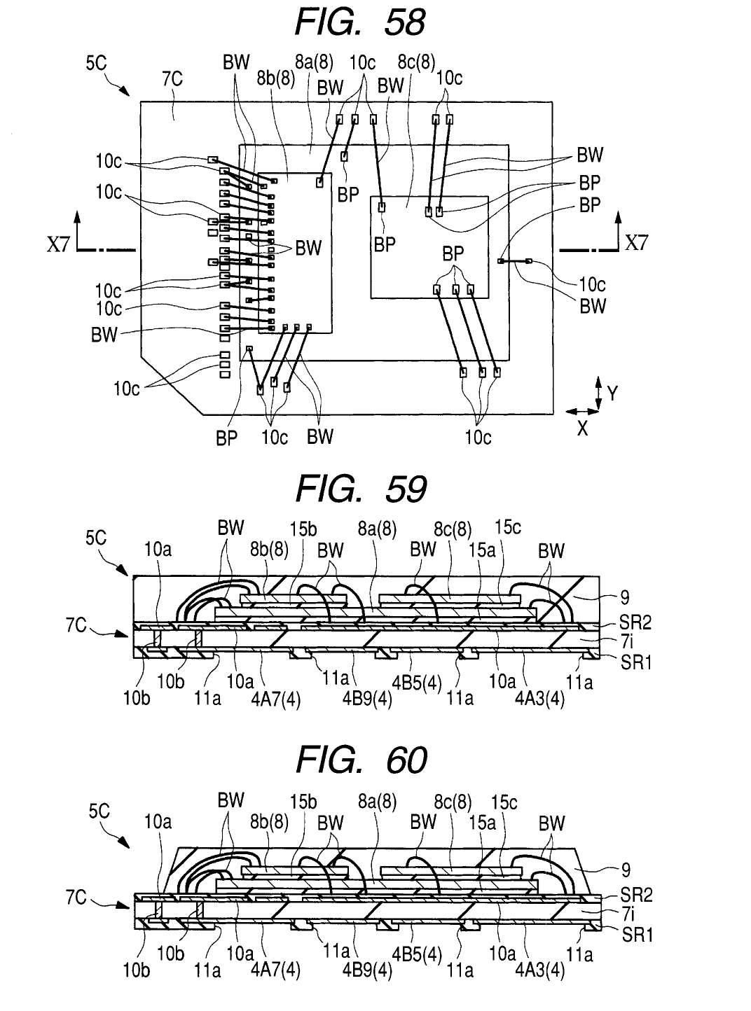

The main chip portion 5C includes a wiring board 7C, semiconductor chips 8 (8a to 8c) mounted on the wiring board 7C, and a sealing body 9 which seals the semiconductor chips 8. FIG. 56 is a plan view of a first main surface of the main chip portion 5C, FIGS. 57 and 58 are plan views of a second main surface of the main chip portion 5C, FIG. 59 is a sectional view taken on line X7-X7 in FIGS. 57 and 58, and FIG. 60 is a sectional view taken on line X7-X7 in FIGS. 57 and 58, showing a modification of FIG. 59. The sealing body 9 is not shown in FIGS. 57 and 58. In FIG. 57, a part of wiring in the wiring board 7C is shown in a see-through manner.

The construction of the wiring board 7C in the main chip portion 5C is the same as that of the wiring board 7A except that the construction of the external connecting terminals is different from that in the wiring board 7A in the first embodiment. More specifically, on a first main surface of the wiring board 7C (the first main surface side of the IC card 1C and card chip 3C), plural external connecting terminals 4B1 to 4B10 for extended interface are arranged in the area sandwiched in between two rows of external connecting terminals 4A1 to 4A4 and 4A5 to 4A8.

The external connecting terminals 4B1 to 4B10 are each formed in a rectangular shape smaller than each of the external connecting terminals 4A1 to 4A8. Planar sizes of the external connecting terminals 4B1 to 4B10 may be the same or different. In the illustrated example, planar sizes of the external connecting terminals 4B1 to 4B10 are gradually smaller outwards from the center of the first main surface of the main chip portion 5C. That is, the external connecting terminals 4B3 and 4B8 located centrally of the first main surface of the main chip portion 5C are the largest in planar size, while the outermost external connecting terminals 4B1, 4B5, 4B6 and 4B10 on the first main surface of the main chip portion 5C are the smallest in planar size.

Further, the external connecting terminals 4B1 to 4B10 are arranged in a state in which their center line positions in the second direction Y are displaced in the second direction Y from center line positions in the second direction Y of the external connecting terminals 4A1 to 4A8. For example, in the case of a type wherein connector pins extend in the right and left direction in FIG. 56 and come into contact with external connecting terminals 4, if center line positions in the second direction Y of the external connecting terminals 4B1 to 4B10 and those of the external connecting terminals 4A1 to 4A8 are coincident with each other, there occurs overlapping of connector pins and thus the layout of connector pins becomes difficult. On the other hand, if the said center line positions are displaced in the second direction, it is possible to facilitate the layout of connector pins without overlapping or large bending of the connector pins.

The constructions of wiring lines 10a, wiring connections and electrodes 10c are the same as those described above with reference to FIGS. 8 to 12 in the first embodiment. Also as to the construction of through holes 10b, it is the same as that described above with reference to FIGS. 13 to 16 in the first embodiment. Moreover, the constructions of the semiconductor chips 8 (8a to 8c) and wires BW are the same as these described in the first embodiment (in FIG. 57 wires BW are indicated by broken lines to make the drawing easier to see). Likewise, the construction of the sealing body 9 is the same as in the first embodiment. Further, the constructions of the IC card microcomputer circuit and control circuit are the same as in the first embodiment.

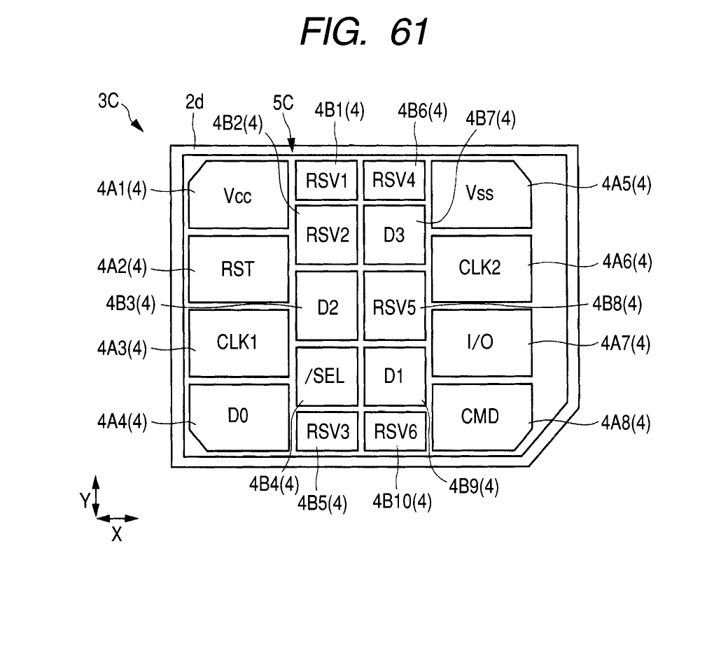

FIG. 61 shows an example of functions (signals) of the external connecting terminals 4 in the card chip 3C.

Of the external connecting terminals 4, the external connecting terminals 4A1 to 4A8 are the same as those described in the first embodiment. A description will here be given about the external connecting terminals 4B1 to 4B10 for extended interface.

The external connecting terminals 4B1, 4B2, 4B5, 4B6, 4B8 and 4B10 are reserve (RSV1 to RSV6) terminals for future functions. For example, the external connecting terminals 4B5 and 4B6 may be assigned to non-contact card interface. It is also possible to assign the external connecting terminals 4B1, 4B2, 4B5, 4B6, 4B8 and 4B10 to three signals of S2C in non-contact card interface or four signals of transmission, reception, mode selection and clock signals.

The external connecting terminals 4B9, 4B3 and 4B7 are data signal (D1 to D3) terminals and the external connecting terminal 4B4 is a mode selection terminal for a signal (/SEL) which switches over between independent operation and interlocked operation of the memory card circuit and the IC card microcomputer circuit.

The layout of the external connecting terminals 4A4, 4A6, 4A8, 4B3, 4B4, 4B7 and 4B9 corresponds to a signal layout which is adopted in the application of for example a 4-bit bus HS-MMC interface. As noted previously, among the external connecting terminals for interface (here 4A4, 4A6 and 4A8) conforming to ISO7816-3 there is included one used as an external connecting terminal (or extended terminal) for the transmission and reception of signals in the memory card circuit. In this case, MMC, SD (Secure Digital), and Memory Stick are mutually applicable. Data signals D0 to D3, a command signal CMD and a clock signal CLK of MMC and SD correspond respectively to data signals DO to D3, a B/S bus state signal and a clock signal SCLK of Memory Stick.

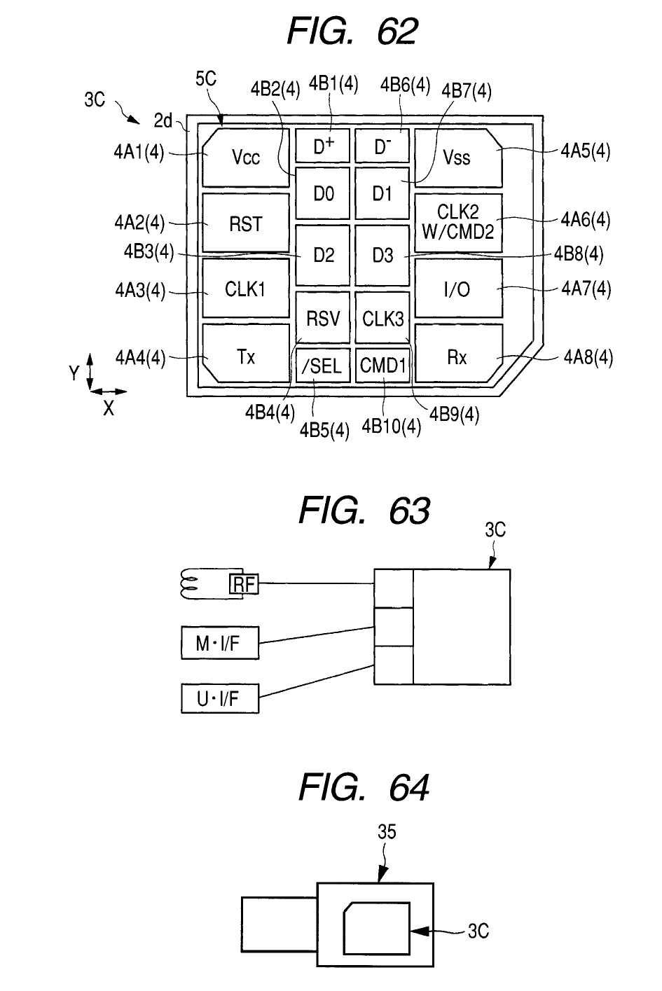

FIG. 62 shows another example of functions (signals) of external connecting terminals in the card chip 3C.

The external connecting terminal 4A4 is a transmission signal (Tx) terminal, the external connecting terminal 4A8 is a reception signal (Rx) terminal, and the external connecting terminal 4A6 is a clock signal (CLK2) terminal with a command signal (CMD2) superimposed thereon. This is advantageous to use in interface when digitizing the non-contact card function.

The external connecting terminals 4B1 and 4B6 are USB signal (D+, D−) terminals and the external connecting terminals 4B2, 4B7, 4B3 and 4B8 are data signal (D0 to D3) terminals for memory card circuit interface. The external connecting terminal 4B4 is a reserve (RSV) terminal. The external connecting terminal 4B4 may be made a command (CMD2) signal terminal separated from the clock signal (CLK2) at the external connecting terminal 4A6. The external connecting terminal 4B5 is a mode selection terminal for the switching signal (/SEL). The external connecting terminal 4B9 is a clock signal (CLK3) terminal for memory card circuit interface. The external connecting terminal 4B10 is a command signal (CMD1) terminal for memory card circuit interface.

In the card chip 3C described above, the exchange of information becomes possible with use of different interfaces, as shown in FIG. 63. For example, in case of exchanging information within the card chip 3C through for example a non-contact interface RF and in terms of NFC (Near Field Communication), the exchanged data can be further exchanged through a memory card circuit interface M-I/F (MMC, SD or interface for memory stick) thereafter or at the same time, and vice versa.

Likewise, in case of exchanging information within the card chip 3C through the non-contact interface RF, the exchanged data can be further exchanged through a USB interface U-I/F thereafter or at the same time, and vice versa.

Further, after or simultaneously with exchange of information within the card chip 3C through the memory card circuit interface, the exchanged data can be further exchanged through the USB interface U-I/F. For example, in a certain host, data can be written to the card chip 3C through the memory card circuit interface, while in another host data stored in the card chip 3C can be read out through the USB interface, and vice versa.

Even with such plural interfaces, each function can be used independently through the non-contact card interface RF, memory card circuit interface M-I/F, USB interface U-I/ or IC card circuit interface (smart card).

As shown in FIG. 64, by loading the card chip 3C of this tenth embodiment to a USB key 35, it is possible to obtain an individual-dedicated USB key.

### Eleventh Embodiment

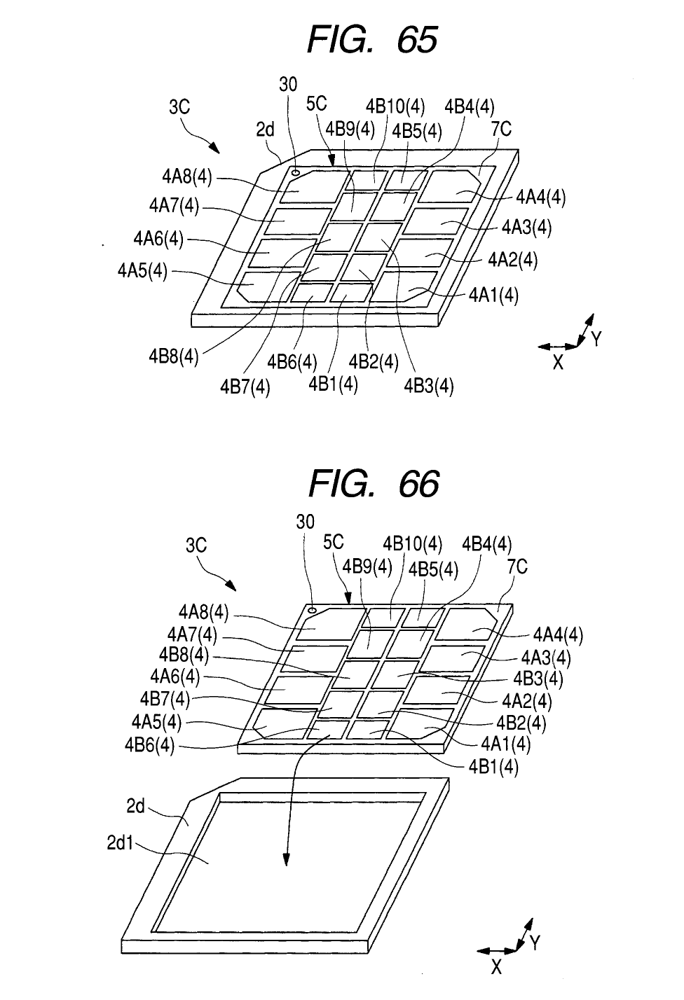

FIG. 65 is a perspective view of a first main surface side of a card chip 3C according to an eleventh embodiment of the present invention and FIG. 66 is an exploded perspective view of the card chip 3C shown in FIG. 65. A perspective view of a second main surface side of the card chip 3C shown in FIG. 65 is omitted because it is the same as FIG. 53.

In this eleventh embodiment, as in the second embodiment, one corner of the wiring board 7C in the main chip portion 5C of the card chip 3C described in the tenth embodiment is not formed with a large chamfered portion, but the wiring board 7C is formed in a square shape in plan. In this case, a cutting process for forming a chamfered portion at one corner of the wiring board 7C can be omitted and therefore it is possible to simplify the process of fabricating the wiring board 7C. As in the second embodiment, a recess 2d1 of a cap 2d is also formed in a square shape in plan to match the planar shape of the wiring board 7C. Further, as in the second embodiment, an alignment mark 30 is formed near a corner of the first main surface of the wiring board 7C, whereby it is possible to prevent the wiring board 7C from being inserted in a wrong direction. Other constructional points are the same as in the tenth embodiment.

### Twelfth Embodiment

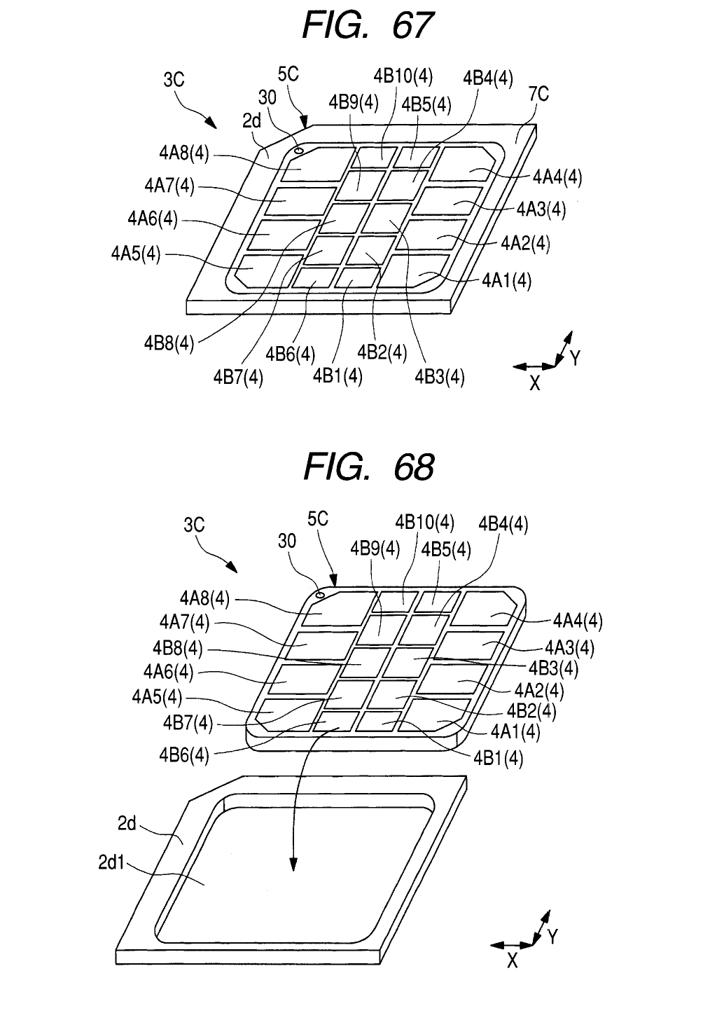

FIG. 67 is a perspective view of a first main surface side of a card chip 3C according to a twelfth embodiment of the present invention and FIG. 68 is an exploded perspective view of the card chip 3C shown in FIG. 67. A perspective view of a second main surface side of the card chip 3C shown in FIG. 67 is the same as FIG. 53 and is therefore omitted.

In this twelfth embodiment, as in the third embodiment, the wiring board 7C in the main chip portion 5C of the card chip 3C described in the tenth embodiment is formed in a square shape of round corners in plan. A recess 2d1 of a cap 2d is also formed in a square shape of round corners in plan to match the planar shape of the wiring board 7C. Further, an alignment mark 30 is formed near a corner of the first main surface of the wiring board 7C as in the third embodiment, whereby it is possible to prevent the wiring board 7C from being inserted in a wrong direction. Other constructional points are the same as in the tenth embodiment.

### Thirteenth Embodiment

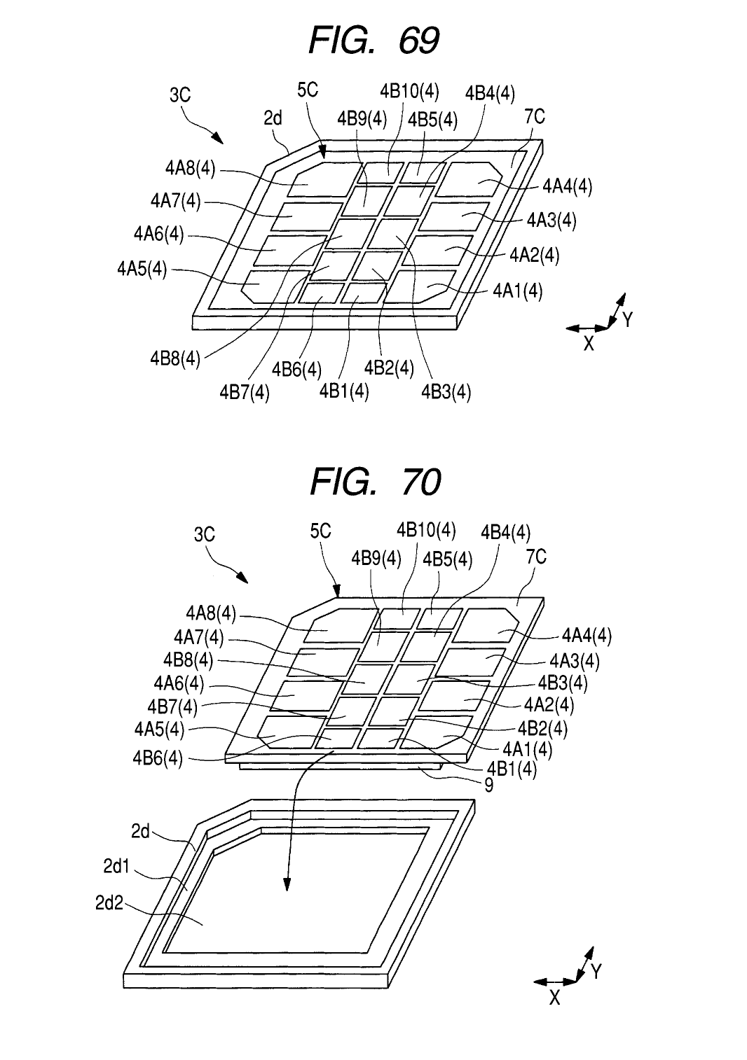

FIG. 69 is a perspective view of a first main surface side of a card chip 3C according to a thirteenth embodiment of the present invention and FIG. 70 is an exploded perspective view of the card chip 3C shown in FIG. 69. A perspective view of a second main surface side of the card chip 3C shown in FIG. 69 is omitted because it is the same as FIG. 53.

In this thirteenth embodiment, as in the fourth embodiment, a recess of a cap 2d which accommodates a main chip portion 5C is formed in stages. That is, in the bottom of the recess 2d1 of the cap 2d there is formed a deeper recess 2d2.

A sealing body 9 of the same construction as FIG. 12 referred to in the first embodiment is formed on a second main surface of a wiring board 7C. The wiring board 7C is fitted in the recess 2d1 and the sealing body 9 on the second main surface of the wiring board 7C is fitted in the recess 2d2. Other constructional points are the same as in the tenth embodiment.

### Fourteenth Embodiment

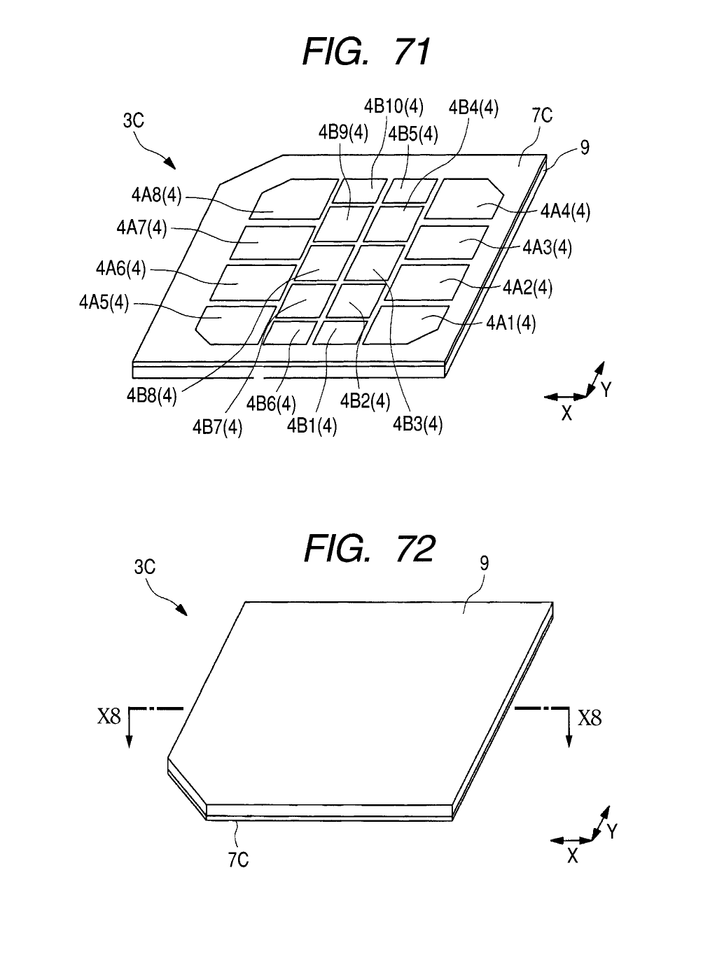

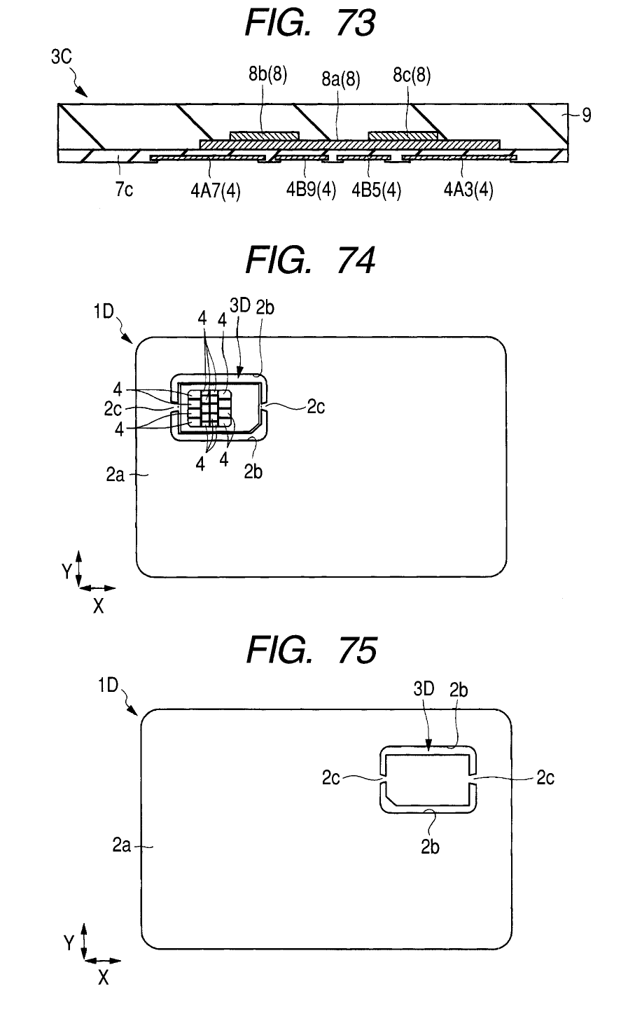

FIG. 71 is a perspective view of a first main surface side of a card chip 3C according to a fourteenth embodiment of the present invention, FIG. 72 is a perspective view of a second main surface side of the card chip 3C shown in FIG. 71, and FIG. 73 is a sectional view taken on line X8-X8 in FIG. 72.

In the card chip 3C of this fourteenth embodiment, as in the fifth embodiment, a cap 2d is not used, but a part of the outline of the card chip 3C is formed by a sealing body 9. In this case, it is possible to obtain the same effect as that described in the fifth embodiment. That is, since the thickness of the cap 2d can be made zero, it is possible to increase the allowance for thickness of the sealing body 9 and hence possible to stack a large number of semiconductor chips 8a for the memory circuit, thereby increasing the memory capacity. Thus, it is possible to stack a large number of semiconductor chips 8 on the second main surface of the wiring board 7C and thereby improve the function. Moreover, since the restriction on the height of wires BW can be eased, it is possible to facilitate the assembly of the card chip 3C. Further, since the cap 2d is not used, it is not necessary to take the mechanical strength of the cap into account. Other constructional points are the same as in the tenth embodiment. As in the fifth embodiment, it is preferable that a corner of the card chip 3C (the sealing body 9 and the wiring board 7C) be tapered in a rounded shape.

### Fifteenth Embodiment

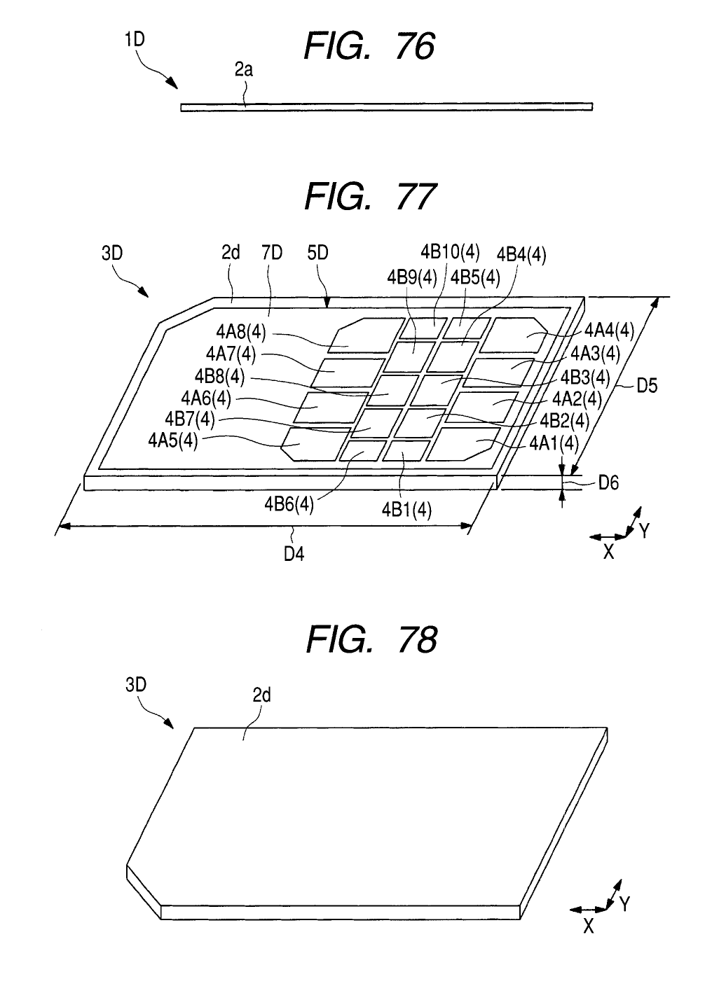

FIG. 74 is an entire plan view of a first main surface of an IC card 1D having a semiconductor device according to a fifteenth embodiment of the present invention, FIG. 75 is an entire plan view of a second main surface as a back side of the first main surface of the IC card 1D shown in FIG. 74, and FIG. 76 is a side view of the IC card shown in FIGS. 74 and 75.

The IC card 1D is, for example, a standard-size SIM card or UIM card. The outline of the IC card 1D is generally rectangular and outline dimensions thereof are, for example, about 85.6 mm×54 mm×0.76 mm.

An aperture 2b is formed in a corner position spaced away from the center of a card frame 2a of the IC card 1D and a card chip 3D is fitted in the aperture 2b snugly in a state in which it is jointed to the card frame 2a and supported by a support portion 2c. The construction of the card chip 3D is the same as the construction of the card chip 3C of the tenth embodiment except that its size is larger than that of the card chip 3C of the tenth embodiment.

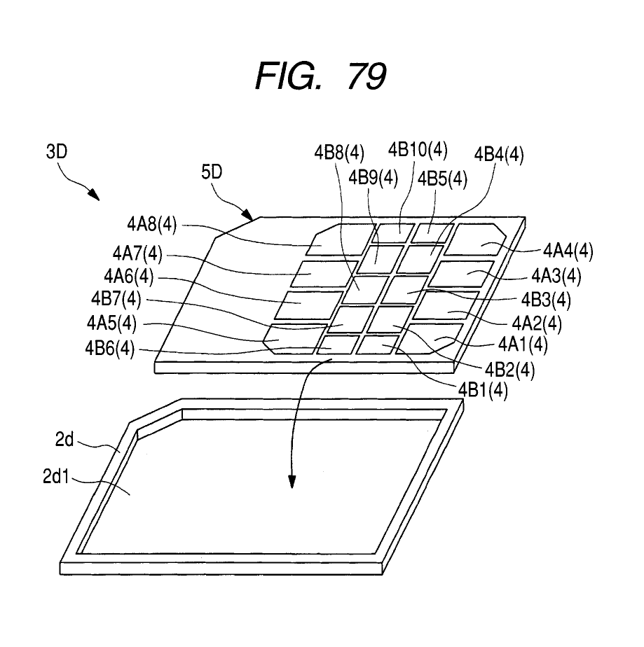

FIG. 77 is a perspective view of a first main surface side of the card chip 3D shown in FIGS. 74 and 75, FIG. 78 is a perspective view of a second main surface side of the card chip 3D shown in FIG. 77, and FIG. 79 is an exploded perspective view of the card chip 3D shown in FIG. 77.

The card chip 3D has, for example, a rectangular outline in conformity with the outline standard of standard-size SIM and UIM cards. One corner on its front side is largely chamfered for index. Outline dimensions (D4×D5×D6) of the card chip 3D is, for example, about 25 mm×15 mm×0.76 mm.

As in the tenth embodiment, eight external connecting terminals (ISO7816 terminals) 4A1 to 4A8 (4) for interface conforming to ISO/IEC7816-3 which is for IC card function and ten external connecting terminals (non-ISO7816 terminals, extended terminals) 4B1 to 4B10 (4) for extended interface not conforming to ISO/IEC7816-3 are arranged on the first main surface of the card chip 3D (corresponding to the first main surface of the IC card 1C) in an exposed state to the exterior. The constructions of the external connecting terminals 4A1 to 4A8 and 4B1 to 4B10 (4) are the same as in the tenth embodiment and therefore an explanation thereof is here omitted. Also in this fifteenth embodiment the external connecting terminals 4B1 to 4B10 (4) for extended interface are arranged in the area between rows of the external connecting terminals 4A1 to 4A4 and 4A5 to 4A8 conforming to ISO/IEC7816-3, whereby the memory card function and other electronic circuit functions can be incorporated into the card chip 3D and hence it is possible to improve the function of the card chip 3D.

A main chip portion 5D and a wiring board 7D in the card chip 3D are formed a littler smaller than the card chip 3D in plan (the widths of edges of a cap 2d allowed to remain on the first main surface of the card chip 3D are designed to be equal throughout the whole periphery and are, for example, about 0.45 mm). A planar shape of the main chip portion 5D and wiring board 7D is analogous to that of the card chip 3D and one corner on the front side thereof is largely chamfered. The construction of the main chip portion 5D and wiring board 7D is the same as that of the main chip portion 5C and wiring board 7C described in the tenth embodiment and therefore an explanation thereof is here omitted.

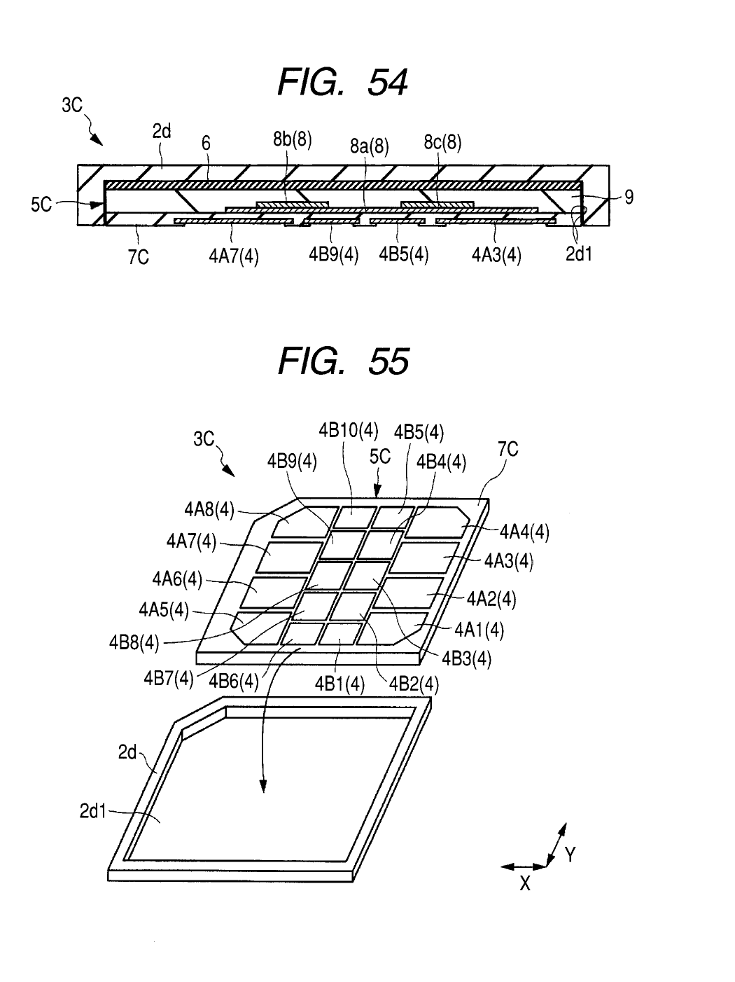

The construction of the cap 2d and that of a recess 2d1 formed in a first main surface of the cap are the same as in the tenth embodiment except that they are formed larger in plan than in the tenth embodiment. Likewise, the construction of the card chip 3D is the same as that of the card chip 3C in the tenth embodiment except that the size thereof is different, and therefore an explanation thereof is here omitted. Also as to the section of the card chip 3D, an explanation thereof is here omitted because it is the same as FIG. 54 except that the size thereof is different.

Also in the case of the standard-size card chip 3D of this fifteenth embodiment there may be adopted any of the constructions shown in FIGS. 65, 66, 67, 68, 69, 70, 71 and 72.

### Sixteenth Embodiment

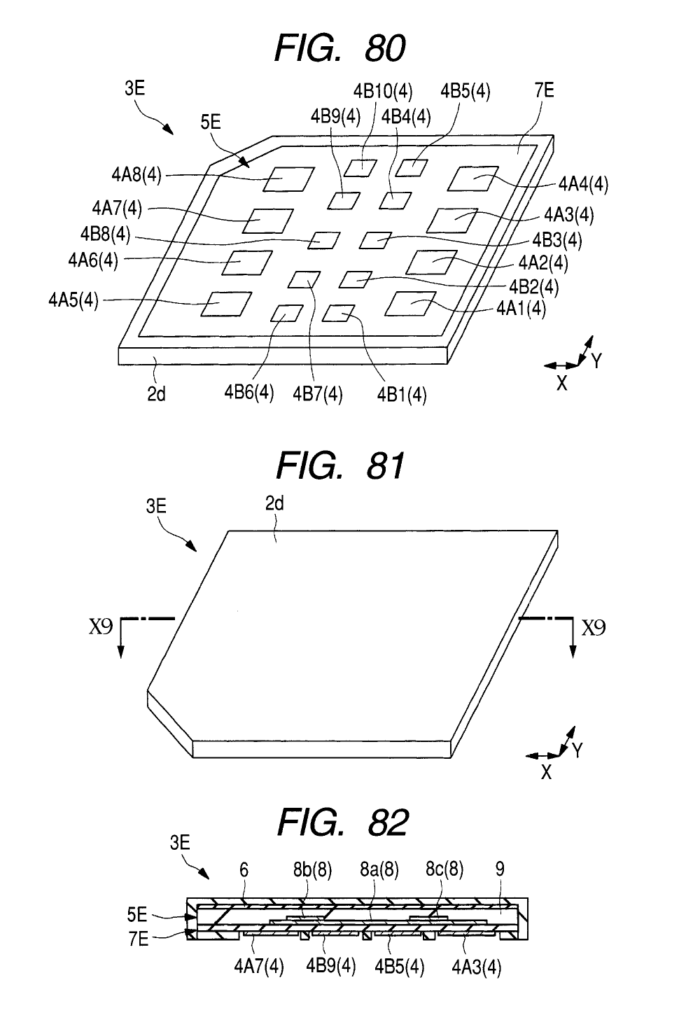

FIG. 80 is a perspective view of a first main surface side of a card chip 3E according to a sixteenth embodiment of the present invention, FIG. 81 is a perspective view of a second main surface side of the card chip 3E shown in FIG. 80, and FIG. 82 is a sectional view taken on line X9-X9 in FIG. 81. The construction of an IC card which accommodates the card chip 3E is the same as in the first and tenth embodiments and is therefore not shown. An exploded perspective view of the card chip 3E is omitted because it is the same as FIG. 55, with the only difference residing in the size of external connecting terminals 4.

The outline of the card chip 3E is formed for example in a quadrangular shape in conformity with the outline standard of mini-size SIM card and mini UIM card. One corner on its front side is largely chamfered for index. Outline dimensions of the card chip 3E are the same as those of the card chips 3A and 3C described in the first embodiment.

Eight external connecting terminals (ISO7816 terminals) 4A1 to 4A8 (4) for interface conforming to ISO/IEC7816-3 which is for IC card function and ten external connecting terminals (non-ISO7816 terminals, extended terminals) 4B1 to 4B10 (4) for extended interface not conforming to ISO/IEC7816-3 are arranged on a first main surface of the card chip 3E (the first main surface side of the IC card 1C) in an exposed state to the exterior. The external connecting terminals 4B1 to 4B10 are arranged in the area sandwiched in between two rows of the external connecting terminals 4A1 to 4A4 and 4A5 to 4A8.

By thus disposing the external connecting terminals 4B1 to 4B10 (4) for extended interface in the area between rows of the external connecting terminals 4A1 to 4A4 and 4A5 to 4A8 conforming to ISO/IEC 7816-3, it is possible to incorporate the memory card function and other electronic circuit functions into the card chip 3E and hence possible to improve the function of the card chip 3E.

The card chip 3E includes a main chip portion 5E and a cap 2d. The construction of the main chip portion 5E is the same as that of the chip main portion 5C described above except that the external connecting terminals 4 arranged on a first main surface of the main chip portion 5E are different in size from those in the main chip portion 5C.

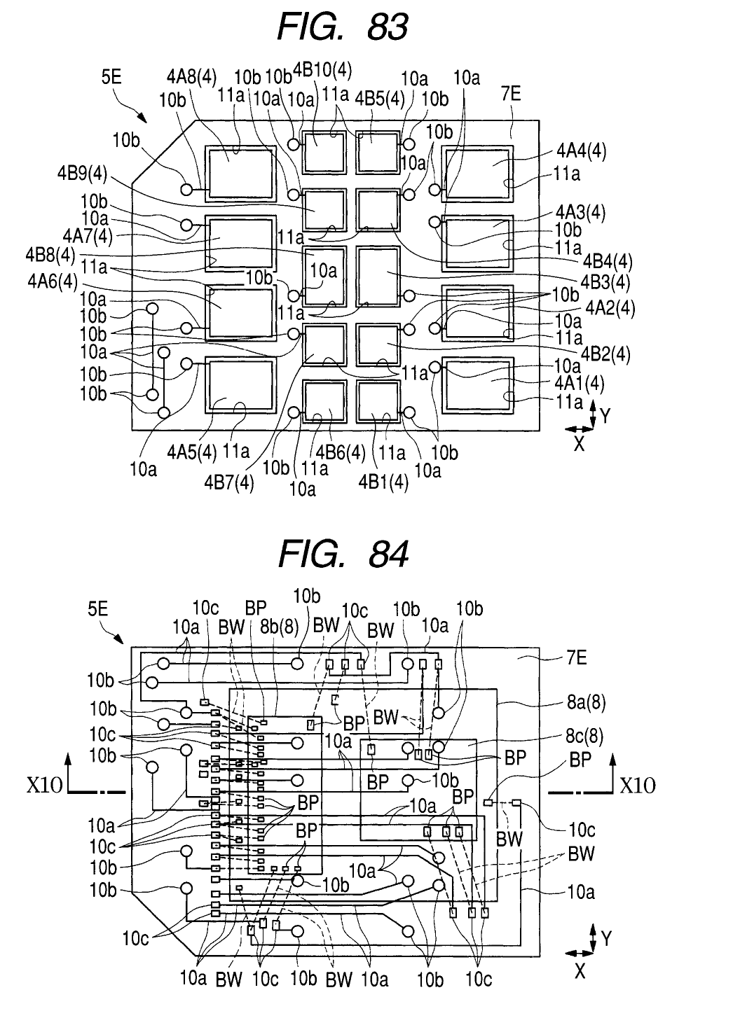

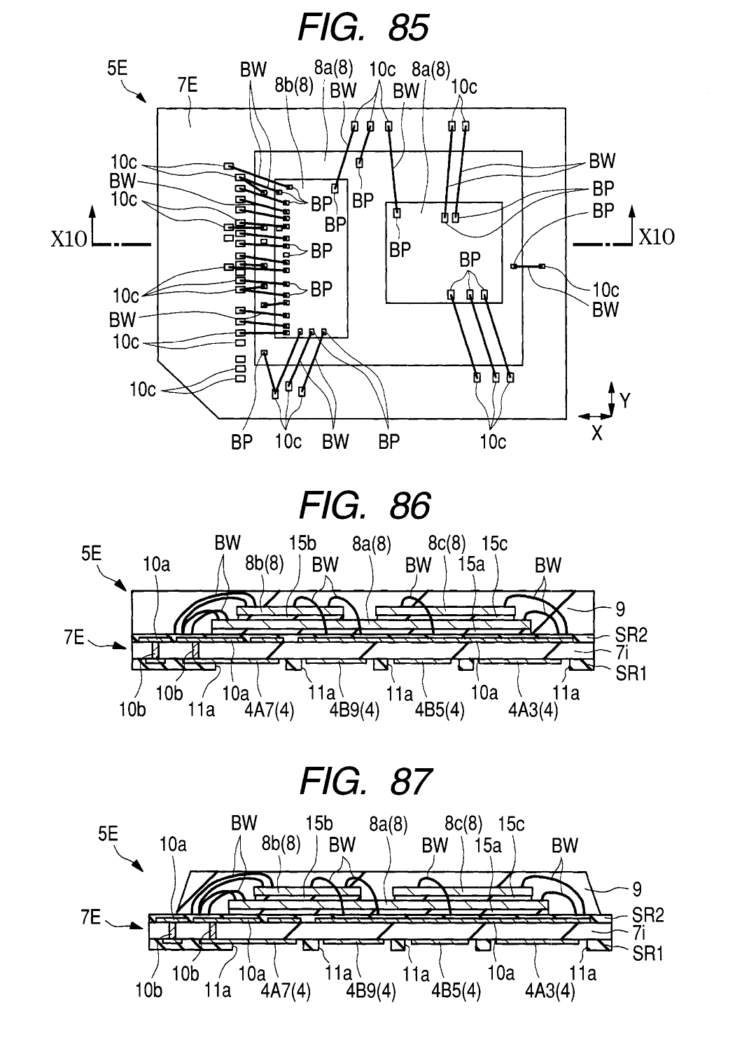

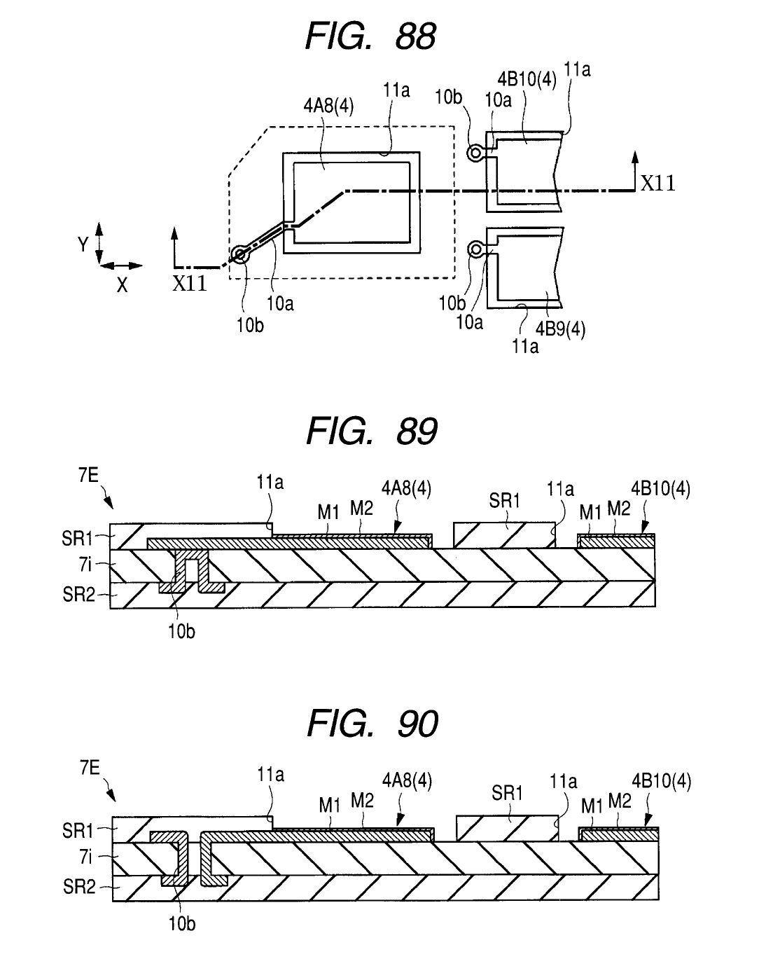

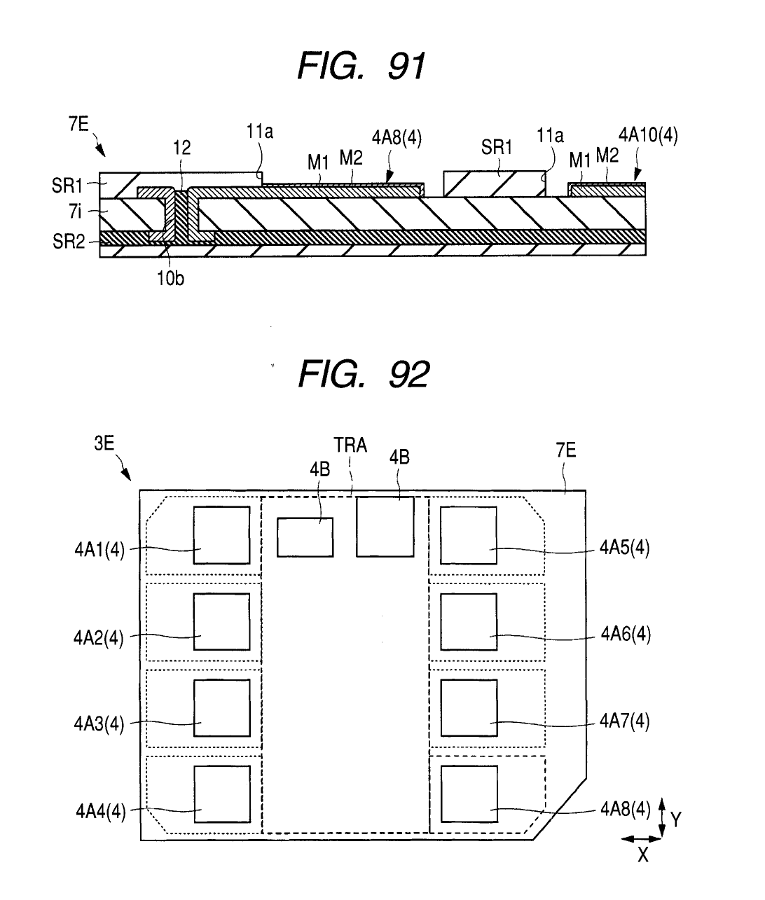

The main chip portion 5Ei includes a wiring board 7E, semiconductor chips 8 (8a to 8c) mounted on the wiring board 7E, and a sealing body 9 which seals the semiconductor chips 8. FIG. 83 is a plan view of the first main surface of the main chip portion 5E, FIGS. 84 and 85 are plan views of a second main surface of the main chip portion 5E shown in FIG. 83, and FIG. 86 is a sectional view taken on line X10-X10 in FIGS. 84 and 85. Further, FIG. 87 is a sectional view taken on line X10-X10 in FIGS. 84 and 85, showing a modification of FIG. 86, FIG. 88 is an enlarged plan view of the external connecting terminals 4, FIG. 89 is a sectional view taken on line X11-X11 in FIG. 88, and FIGS. 90 and 91 are sectional views taken on line X11-X11 in FIG. 88, showing a modification of FIG. 89. In FIGS. 84 and 85 the sealing body 9 is not shown. In FIG. 84, a part of wiring in the wiring substrate 7E is shown in a see-through manner. For comparison purpose, a broken line in FIG. 88 indicates an external connecting terminal 4 described in the tenth embodiment.

The plural external connecting terminals 4B1 to 4B10 for extended interface are arranged on a first main surface of the wiring board 7E in the main chip portion 5E (the first main surface of the card chip 3E) and in the area sandwiched in between two rows of the external connecting terminals 4A1 to 4A4 and 4A5 to 4A8.

In this sixteenth embodiment, the size of each of the external connecting terminals 4 (4A1 to 4A8 and 4B1 to 4B10) is set to a minimum size required which is smaller than in the tenth embodiment.

The external connecting terminals (4A1 to 4A8 and 4B1 to 4B10) are electrically connected to through holes 10b formed outside the external connecting terminals 4 through wiring lines 10a which extend outside the external connecting terminals 4 with the respective outer peripheries as start points. That is, in this sixteenth embodiment, the through holes 10b and wiring lines 10a are disposed in empty areas resulting from the reduction in size of the external connecting terminals 4.

Further, apertures 11a formed in solder resist SR1 are positioned outside the external connecting terminals 4 (4A1 to 4A8 and 4B1 to 4B10). That is, the solder resist SR1 does not overlap the external connecting terminals 4 and the external connecting terminals 4 are exposed substantially throughout the whole surfaces (upper and side surfaces) thereof. Thus, the entire upper surfaces of the external connecting terminals serve as connection areas. In this case, as shown in FIGS. 89 to 91, a plating layer M2 is formed not only on the upper surfaces of the external connecting terminals 4 but also on the side faces of the terminals 4.

FIG. 92 is an entire plan view of the first main surface of the wiring board 7E, illustrating a layout area TRA of the external connecting terminals 4B (4B1 to 4B10) for extended interface. The external connecting terminals 4B (4B1 to 4B10) are arranged in the layout area TRA which is sandwiched in between rows maximum terminal areas of the external connecting terminals 4A1 to 4A8 indicated by broken lines.

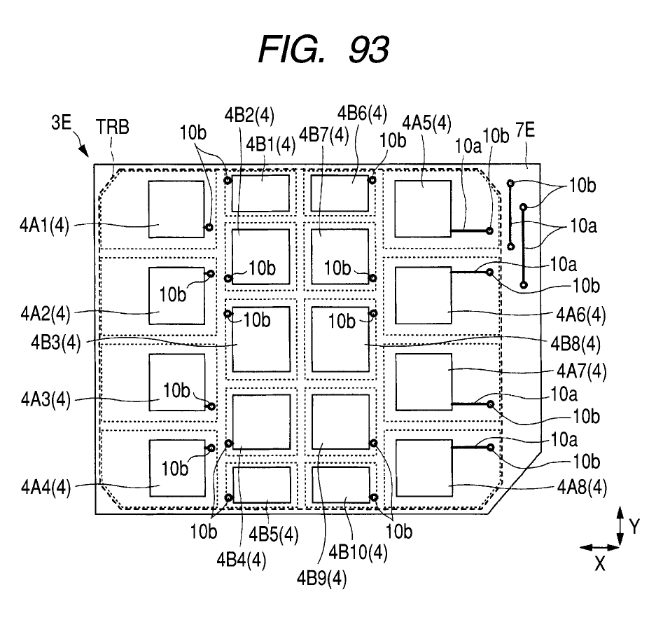

FIG. 93 is an entire plan view of the first main surface of the wiring board 7E, illustrating a layout area TRB of wiring (including wiring lines 10a and through holes 10b). In this sixteenth embodiment, among the wiring lines 10a and through holes 10b there are those disposed outside the external connecting terminals 4A1 to 4A8 and 4B1 to 4B10 and inside the layout area TRB including the whole of maximum terminal areas of the external connecting terminals 4A1 to 4A8 indicated by broken lines.

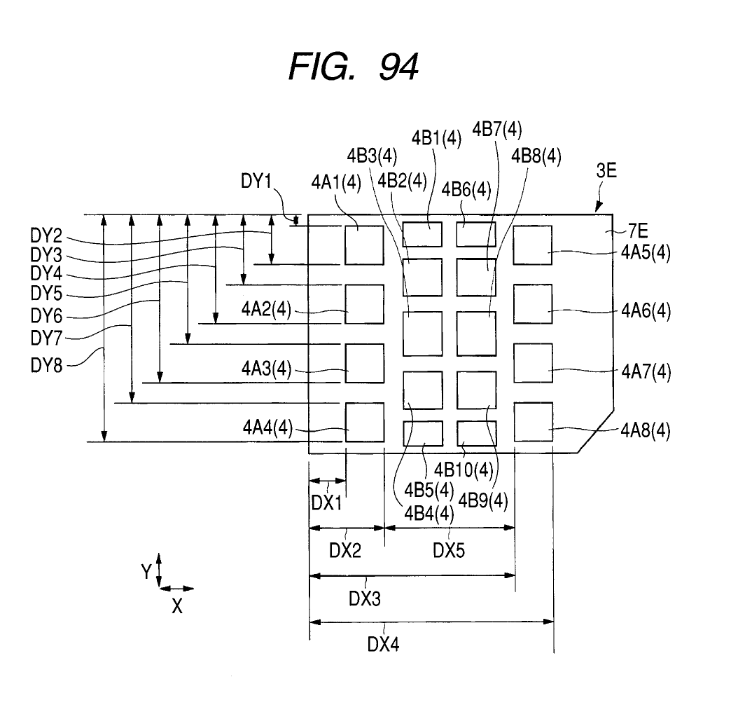

FIG. 94 shows concrete dimensional examples of the external connecting terminals 4 (4A1 to 4A8 and 4B1 to 4B10) used in this sixteenth embodiment. In the first direction X, for example the size DX1 is about 2.15 mm as Max value, the DX2 is about 4.15 mm as Min value, the size DX3 is about 9.77 mm as Max value, the size DX4 is about 11.77 mm as Min value, and the size DX5 is about 4.15 to 9.77 mm. In the second direction Y, for example the size DY1 is about 1.34 mm as Max value, the size DY2 is about 3.04 mm as Min value, the size DY3 is about 3.88 mm as Max value, the size DY4 is about 5.58 mm as Min value, the size DY5 is about 6.42 mm as Max value, the size DY6 is about 8.12 mm as Min value, the size DY7 is about 8.96 mm as Max value, and the size DY8 is about 10.662 mm as Min value.

Thus, according to this sixteenth embodiment, since the external connecting terminals 4 are made small in size, empty areas can be formed within the first main surface of the wiring board 7E in a mini-size SIM card, and by disposing wiring (including the wiring lines 10a and through holes 10b) in the empty areas it is possible to improve the degree of freedom in layout of the wiring.

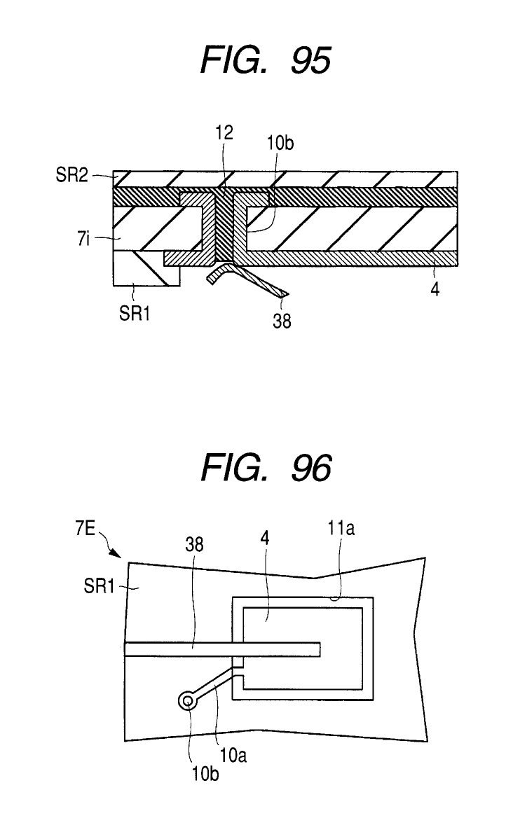

FIG. 95 is a sectional view of a principal portion of the wiring board where a through hole 10b is formed in the connection area of an external connecting terminal 4 so as to extend through both upper and lower surfaces of the external connecting terminal 4. In this case, the wiring board having such through holes is low in cost, but may be unemployable because there is a case where a connector pin 38 comes into contact with a concave or convex in the exposed portion of the through hole 10b, resulting in the exposed portion being chipped or damaged, or a case where there occurs contact imperfection of the connector pin 38 for the external connecting terminal 4. On the other hand, FIG. 96 is an enlarged plan view of a principal portion of an external connecting terminal 4 on the wiring board 7E in this sixteenth embodiment. In the illustrated example, the connection area of the connector pin 38 and the through hole 10b are spaced away from each other and hence the connector pin 38 does not contact the through hole 10b, so that the aforesaid problems do not occur. Thus, the wiring board 7E having such through holes is employable, whereby it is possible to reduce the cost of the card chip 3E.

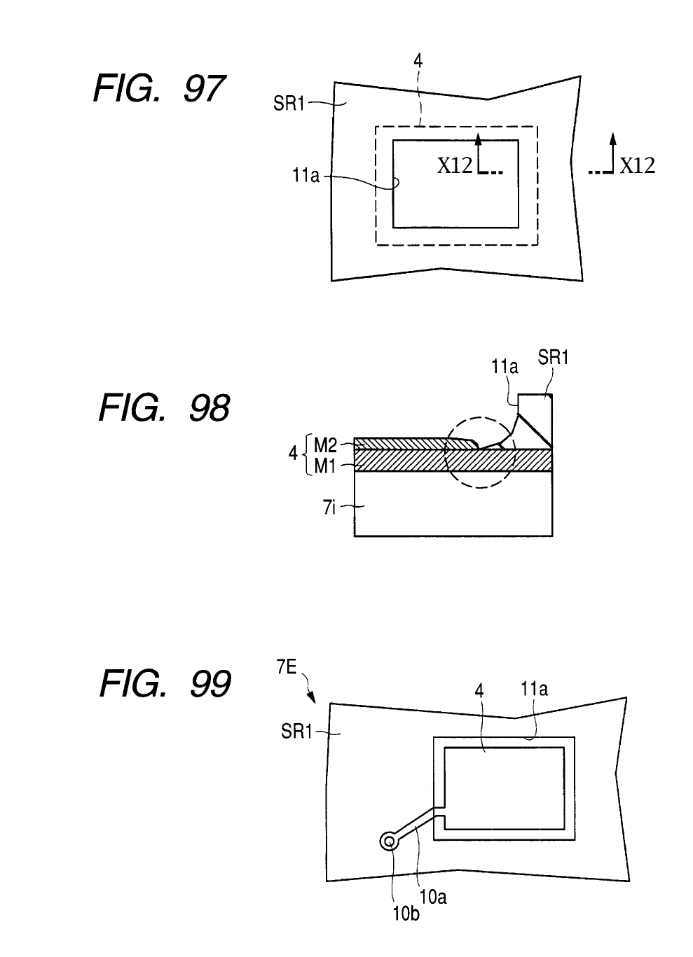

FIG. 97 is a plan view of a principal portion of a wiring board having a construction wherein a part of solder resist SR1 overlaps the outer periphery of an upper surface of an external connecting terminal 4 and FIG. 98 is an enlarged sectional view taken on line X12-X12 in FIG. 97. In the illustrated example there sometimes is a case where a portion insufficient in film thickness of the solder resist SR1 is formed in an outer periphery portion (the portion enclosed with a broken line in FIG. 98) of each aperture 11a of the solder resist SR1. The plating layer M1 is not formed in this portion and therefore if the portion insufficient in film thickness peels off later, a main conductor layer M2 as a base material may becomes exposed from there, resulting in corrosion of the exposed portion. On the other hand, FIG. 99 is an enlarged plan view of a principal portion of an external connecting terminal 4 on the wiring board 7E in this sixteenth embodiment. In this embodiment, end portions (i.e., apertures 11a) of the solder resist SR1 are not disposed on the upper surfaces of external connecting terminals 4, but are disposed outside the external connecting terminals. Therefore, a portion insufficient in film thickness of the solder resist SR1 is not formed on the upper surface of any external connecting terminal 4 and substantially the whole surface (upper and side surfaces) of each external connecting surface is covered with the plating layer M1, so that the foregoing problem of corrosion of the external connecting terminals 4 can be greatly decreased.

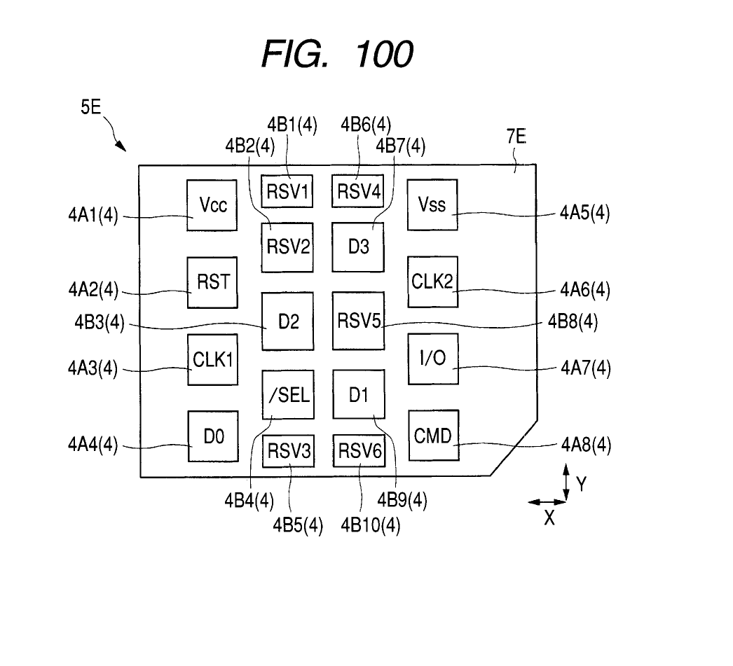

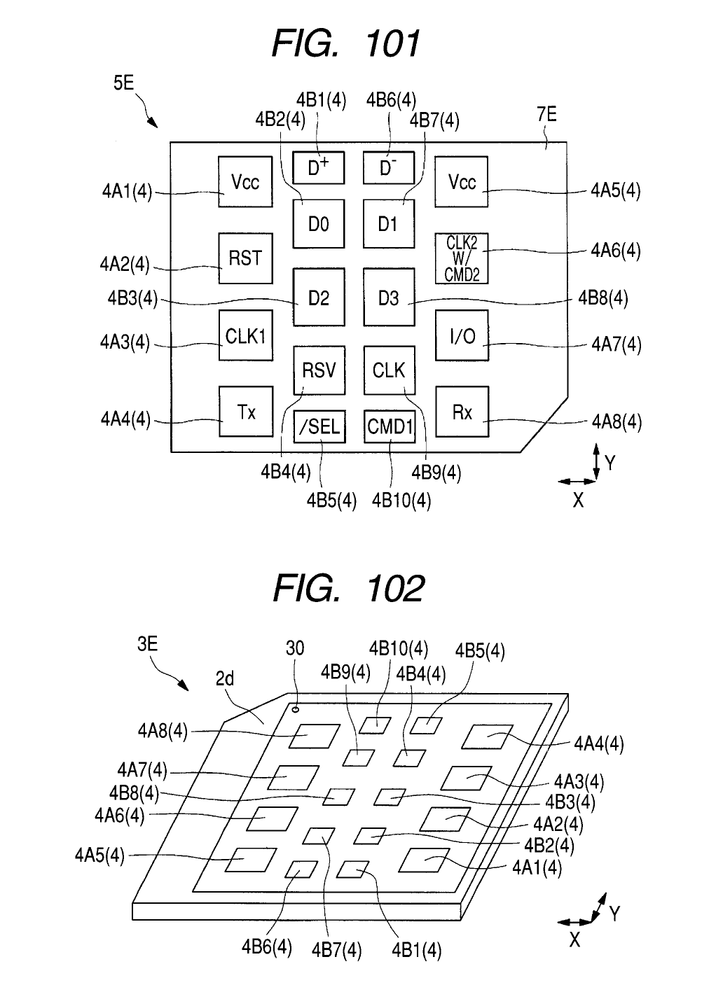

A dimensional relation between the external connecting terminals 4A1 to 4A8 and 4B1 to 4B10, a relative layout relation between the external connecting terminals 4A1 to 4A8 and 4B1 to 4B10, and a dimensional relation among the external connecting terminals 4B1 to 4B10, are the same as those described in the tenth embodiment. The constructions of wiring lines 10a, wiring connections and electrodes 10c, as well as the constructions of semiconductor chips 8 (8a to 8c) and wires BW, are also the same as in the first and tenth embodiments (in FIG. 84 the wires BW are indicated by broken lines to make the drawing easier to see). As to the sealing body 9, it is the same as in the first and tenth embodiments. The constructions of the IC card microcomputer circuit and the control circuit are also the same as in the first embodiment. Other constructional points, including the construction of through holes 10b shown in FIGS. 88 to 91, are the same as those described above with reference to FIGS. 13 to 16 in the first embodiment. FIG. 100 shows an example of functions (signals) of the external connecting terminals 4 in the card chip 3E of this sixteenth embodiment. The layout of signals at the external connecting terminals 4 in FIG. 100 is the same as that described in connection with FIG. 61. Likewise, the layout of signals at the external connecting terminals 4 in FIG. 101 is the same as that described in connection with FIG. 62.

### Seventeenth Embodiment

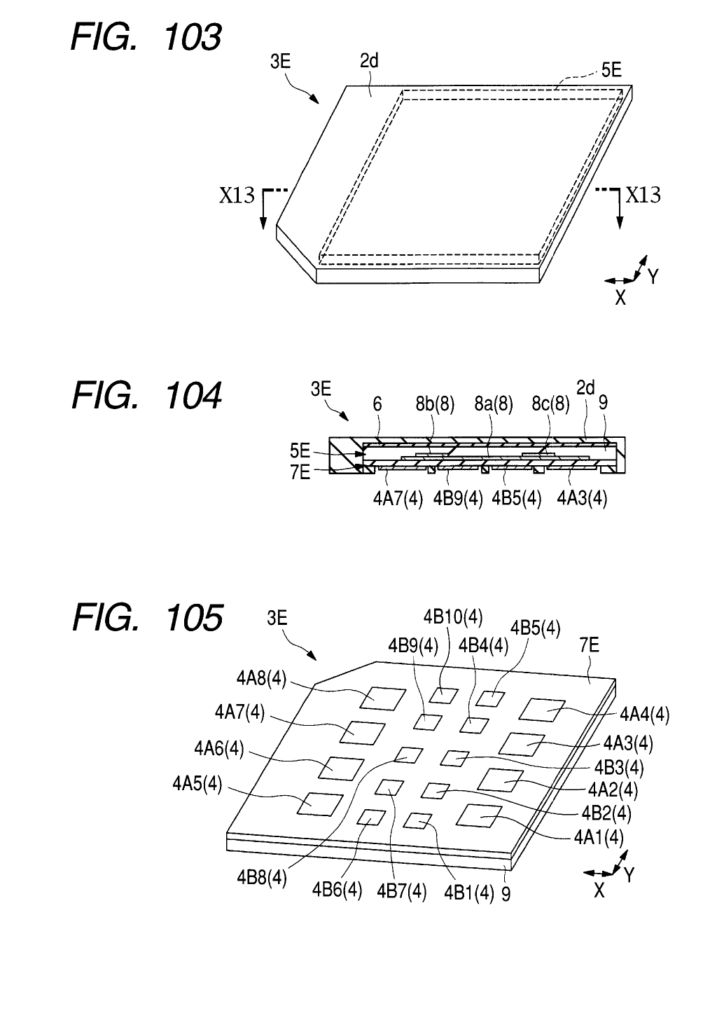

FIG. 102 is a perspective view of a first main surface side of a card chip 3E according to this seventeenth embodiment, FIG. 103 is a perspective view of a second main surface side of the card chip 3E shown in FIG. 102, and FIG. 104 is a sectional view taken on line X13-X13 in FIG. 103. In FIG. 103, a main chip portion 5E is indicated by a broken line.

In this seventeenth embodiment, as in the second and eleventh embodiments, a large chamfered portion is not formed at a corner of the wiring board 7E of the main chip portion 5E in the card chip 3E described in the sixteenth embodiment, but the wiring board 7E is formed in a square shape in plan. In this case, a cutting process for forming a chamfered portion at a corner of the wiring board 7E can be omitted and therefore it is possible to simplify the process of fabricating the wiring board 7E. Moreover, as in the second and eleventh embodiments, a recess 2d1 of a cap 2d is also formed in a square shape in plan to match the planar shape of the wiring board 7E. Further, as in the second embodiment, an alignment mark 30 is formed near a corner of the first main surface of the wiring board 7E, whereby the wiring board can be prevented from being inserted in a wrong direction. Other constructional points are the same as in the sixteenth embodiment.

The card chip 3E can be constructed in the same manner as in the twelfth and thirteenth embodiments (FIGS. 67, 68, 69 and 70).

### Eighteenth Embodiment

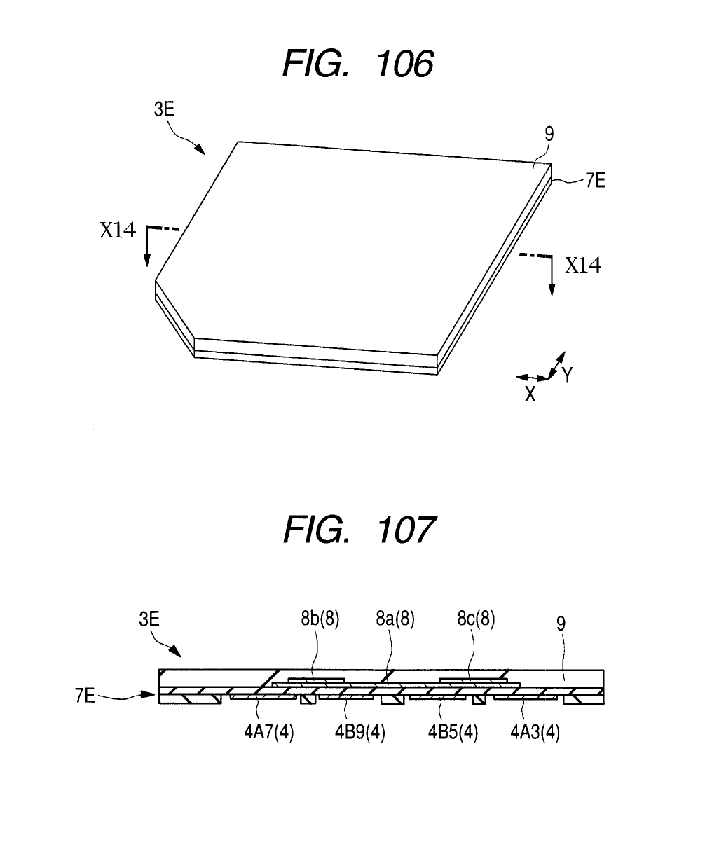

FIG. 105 is a perspective view of a main surface side of a card chip 3E according to an eighteenth embodiment of the present invention, FIG. 106 is a perspective view of a second main surface side of the card chip 3E shown in FIG. 105, and FIG. 107 is a sectional view taken on line X14-X14 in FIG. 106.

In this eighteenth embodiment, as in the fifth and fourteenth embodiments, the card chip 3E does not have a cap 2d and a part of the outline of the card chip 3E is formed by a sealing body 9. In this case it is possible to obtain the same effect as in the fifth and fourteenth embodiments. Other constructional points are the same as in the sixteenth embodiment. Also in this eighteenth embodiment, as in the fifth and fourteenth embodiments, it is preferable that a corner of the card chip 3E (sealing body 9 and wiring board 7E) be tapered in a rounded shape.

### Nineteenth Embodiment

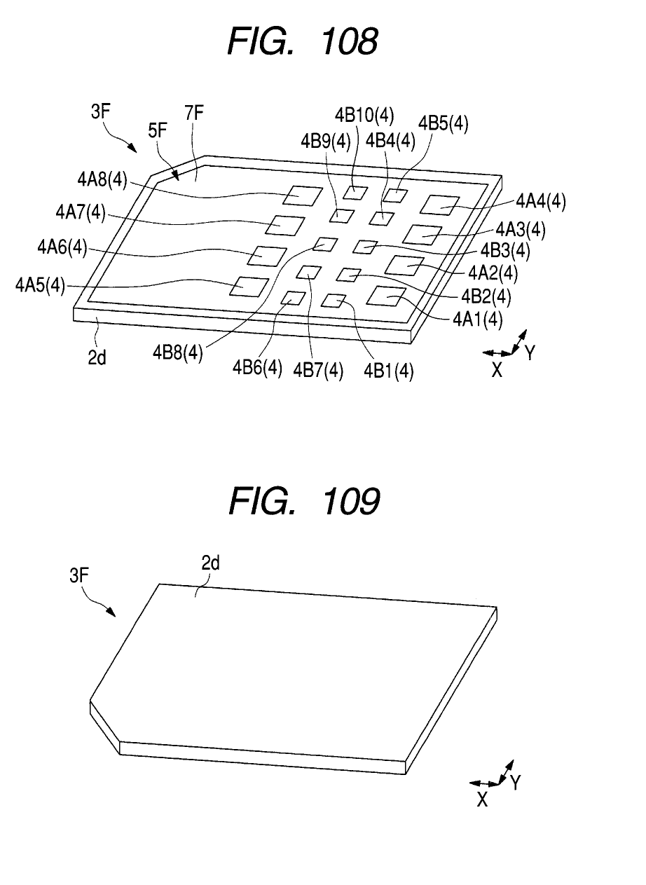

FIG. 108 is a perspective view of a first main surface of a card chip 3F according to a nineteenth embodiment of the present invention and FIG. 109 is a perspective view of a second main surface side of the card chip 3F shown in FIG. 108. An exploded perspective view of FIG. 108 is omitted because it is the same as FIG. 79 except that a difference is recognized in the size of each external connecting terminal 4.

The outline of the card chip 3F is for example in a quadrangular shape in conformity with the outline standard of standard-size SIM and UIM cards. One corner on a front side of the card chip 3F is largely chamfered for index. Outline dimensions (D4×D5×D6) of the card chip 3F are, for example, about 25 mm×15 mm×0.76 mm.

As in the sixteenth embodiment, eight external connecting terminals (ISO7816 terminals) 4A1 to 4A8 (4) for interface conforming to ISO/IEC7816-3 which is for IC card function and ten external connecting terminals (non-ISO7816 terminals, extended terminals) 4B1 to 4B10 (4) for extended terminals not conforming to ISO/IEC7816-3 are arranged on a first main surface of the card chip 3F (corresponding to the first main surface of the IC card 1C) in an exposed state to the exterior. The constructions of the external connecting terminals 4A1 to 4A8 and 4B1 to 4B10 (4) are the same as in the sixteenth embodiment and therefor an explanation thereof is here omitted. Also in this nineteenth embodiment it is possible to obtain the same effect as in the sixteenth embodiment.

A main chip portion 5F and a wiring board 7F in the card chip 3F are formed a little smaller in planar size than the card chip 3F (the widths of edges allowed to remain on the first main surface of the card chip 3F are designed to be equal throughout the whole periphery and are, for example, about 0.45 mm). The main chip portion 5F and the wiring board 7F are formed analogous in planar shape to the card chip 3F and one corner on the front side thereof is largely chamfered. The construction of the main chip portion 5F and wiring board 7F is the same as that of the main chip portions 5C, 5E and wiring boards 7C, 7E described in the tenth and sixteenth embodiments except that the size thereof is different, therefore an explanation thereof is here omitted.

A cap 2d and a recess 2d1 formed in a first main surface of the cap are also the same as those described in the sixteenth embodiment except that they are larger in planar size than in the sixteenth embodiment. The construction of the card chip 3F is the same as that of the card chip 3E of the sixteenth embodiment except that the size thereof is different, therefore an explanation thereof is here omitted. Also as to the section of the card chip 3F, it is not shown because it is the same as FIG. 82 except that the size thereof is different.

Also in the case of the cad chip 3F of standard size according to this nineteenth embodiment there may be adopted any of the constructions shown in FIGS. 102, 103, 67, 68, 69, 70, 105 and 106.

Although the present invention has been described above by way of embodiments thereof, it goes without saying that the invention is not limited by the above embodiments, but that various changes may be made within the scope not departing from the gist of the invention.

For example, in connection with the construction of the external connecting terminals described in the first embodiment, the external connecting terminals 4A1 to 4A8 and 4B0 may be formed in such a small size (minimum size required) as described in the sixteenth embodiment.

Although external connecting terminals for extended interface are used in the first to nineteenth embodiments, even in the case where such external connecting terminals are absent, the external connecting terminals 4A1 to 4A8 may be formed in a small size (minimum size required) and through holes may be formed outside the external connecting terminals 4A1 to 4A8 as in the sixteenth embodiment. Where required in the IC card concerned, the external connecting terminal 4A4 or 4A8 may be omitted.

The present invention is applicable to the manufacturing industry of card type information media.

What is claimed is:

1. A semiconductor device comprising a plurality of terminals formed over a first main surface of a card body, the card body incorporating a card circuit having an IC card circuit and a memory card circuit,
the plural terminals comprising a plurality of ISO7816 terminals connected electrically to the card circuit and a non-ISO7816 terminal connected electrically to the card circuit,
the non-ISO7816 terminal being disposed in an area sandwiched in between rows of the ISO7816 terminals.

2. A semiconductor device according to claim 1,
wherein the card body comprises:
a substrate having the first main surface and a second main surface positioned on a back side of the first main surface;
a semiconductor chip mounted over the second main surface of the substrate and forming the card circuit; and
a sealing body forming a part of the outline of the card body and sealing the semiconductor chip.

3. A semiconductor device according to claim 2, wherein the sealing body is formed by a cap.

4. A semiconductor device according to claim 2, wherein the sealing body is formed by a molding resin.

5. A semiconductor device according to claim 2, wherein the semiconductor chip comprises a first semiconductor chip formed with the IC card circuit, a second semiconductor chip formed with a memory circuit of the memory card circuit, and a third semiconductor chip formed with a control circuit for controlling the operation of the memory circuit.

6. A semiconductor device according to claim 1, wherein the non-ISO7816 terminal is a terminal for a signal for switching over between an independent operation and an interlocked operation of the memory card circuit and the IC card circuit.

7. A semiconductor device according to claim 1, wherein the plurality of non-ISO7816 terminals are arranged between the rows of the ISO7816 terminals.

8. A semiconductor device according to claim 7, wherein a terminal for the memory card circuit is included among the plural non-ISO7816 terminals.

9. A semiconductor device according to claim 7, wherein a terminal for USB is included among the plural non-ISO7816 terminals.

10. A semiconductor device according to claim 1, wherein through holes or wiring lines connected electrically to the plural terminals, or both the through holes and the wiring lines, are formed outside the plural terminals respectively and inside the layout area of the plural ISO7816 terminals.

11. A semiconductor device according to claim 10, wherein the card body includes a substrate having the first main surface and a second main surface positioned on a back side of the first main surface, and the through holes are through type through holes.

12. A semiconductor device according to claim 1, wherein the card body is fixed in a supported state within a card frame.

13. A semiconductor device comprising a plurality of terminals formed over a first main surface of a card body, the card body incorporating a card circuit having an IC card circuit and a memory card circuit,
the plural terminals comprising:
a plurality of ISO7816 terminals connected electrically to the card circuit; and
a non-ISO7816 terminal connected electrically to the card circuit,
the non-ISO7816 terminal being a terminal for a signal for switching over between an independent operation and an interlocked operation of the memory card circuit and the IC card circuit,
the non-ISO7816 terminal being disposed in an area sandwiched in between rows of the ISO7816 terminals.

14. A semiconductor device according to claim 13, wherein the card body is fixed in a supported state within a card frame.

15. A semiconductor device comprising a plurality of terminals formed over a first main surface of a card body, the card body incorporating a card circuit having an IC card circuit and a memory card circuit,
the plural terminals comprising:
a plurality of ISO7816 terminals connected electrically to the card circuit; and
a non-ISO7816 terminal connected electrically to the card circuit,
the plurality of non-ISO7816 terminals being disposed between rows of the ISO7816 terminals.

16. A semiconductor device according to claim 15, wherein the card body is fixed in a supported state within a card frame.

17. A semiconductor device comprising a plurality of terminals formed over a first main surface of a card body, the card body incorporating a card circuit having an IC card circuit and a memory card circuit,
the plural terminals comprising:
a plurality of ISO7816 terminals connected electrically to the card circuit; and
a non-ISO7816 terminal connected electrically to the card circuit,
the non-ISO7816 terminal being disposed in an area sandwiched in between rows of the ISO7816 terminals, through holes or wiring lines connected electrically to the plural terminals, or both the through holes and the wiring lines, being disposed outside the plural terminals respectively or inside the layout area of the plural ISO7816 terminals.

18. A semiconductor device according to claim 17,
wherein the card body includes a substrate having the first main surface and a second main surface as a back side of the first main surface, and the through holes are through type through holes.

19. A semiconductor device according to claim 17, wherein the card body is fixed in a supported state within a card frame.

20. A semiconductor device comprising a plurality of terminals formed over a first main surface of a card body, the card body incorporating a card circuit having an IC card circuit and a memory card circuit,
the plural terminals including a plurality of ISO7816 terminals connected electrically to the card circuit,
through holes or wiring lines connected electrically to the plural ISO7816 terminals, or both the through holes and the wiring lines, being disposed outside the plural ISO7816 terminals respectively and inside the layout area of the plural ISO7816 terminals.

21. A semiconductor device according to claim 20,
wherein the card body includes a substrate having the first main surface and a second main surface positioned on a backside of the first main surface, and the through holes are through type through holes.
